(19) United States
(12) Patent Application Publication
(10) Pub. No.: US 2025/0206404 A1
(43) Pub. Date: Jun. 26, 2025

(54) TIME DISPLAY SYSTEM, DRIVING SYSTEM, ELECTRICALLY ASSISTED VEHICLE, BATTERY PACK, TIME DISPLAY METHOD, AND COMPUTER PROGRAM

(71) Applicant: YAMAHA HATSUDOKI KABUSHIKI KAISHA, Iwata-shi (JP)

(72) Inventors: Kosuke NAKAJIMA, Shizuoka (JP); Kazuya MATSUBARA, Shizuoka (JP); Yoshiyuki RYOGOKU, Shizuoka (JP); Yuemin YU, Shizuoka (JP); Gakuto HOSHIDA, Shizuoka (JP)

(21) Appl. No.: 18/985,274

(22) Filed: Dec. 18, 2024

(30) Foreign Application Priority Data
Dec. 20, 2023 (JP) 2023-214833

(51) Int. Cl. B62J 50/22; B60L 58/12; B62M 6/90; H01M 10/42

(52) U.S. Cl. CPC B62J 50/22; B60L 58/12; B62M 6/90; B60L 2200/12; B60L 2250/16; H01M 10/425; H01M 2220/20

(57) ABSTRACT

A time display system for an electrically assisted vehicle includes a display and at least one processor configured or programmed to acquire time information representing information on a time that is output by a battery pack that supplies electric power to an electric motor that generates drive power to cause the electrically assisted vehicle to travel, and to cause the display to display a current time based on the time information.

### CROSS REFERENCE TO RELATED APPLICATIONS

This application claims the benefit of priority to Japanese Patent Application No. 2023-214833 filed on Dec. 20, 2023. The entire contents of this application are hereby incorporated herein by reference.

### BACKGROUND OF THE INVENTION

### 1. Field of the Invention

The present invention relates to time display systems, driving systems, electrically assisted vehicles, battery packs, time display methods, and non-transitory computer readable media including computer programs.

### 2. Description of the Related Art

Bicycles are widely used by a variety of people regardless of the age or gender as easy-to-use means of transportation. Recently, electrically assisted bicycles, by which power of users performing pedaling is assisted by electric motors, are increasingly widespread (see, for example, Japanese Laid-Open Patent Publication No. 2007-230411).

Such an electric motor is supplied with electric power from a battery mounted on a vehicle, i.e., the electrically assisted bicycle, and thus generates drive power. The electrically assisted bicycle causes the electric motor to generate drive power corresponding to the power of a human body, specifically, the power provided by a user to the pedals, and thus alleviates the load imposed on the user while, for example, traveling on a slope or traveling with cargo.

### SUMMARY OF THE INVENTION

A handle of an electrically assisted bicycle is provided with a display (meter) displaying various information on the electrically assisted bicycle. In the case of having a function of displaying the current time, the display includes a built-in battery cell such as a coin cell battery. The display includes such a built-in battery cell, so that even in a state where a battery pack supplying electric power to an electric motor is detached from the electrically assisted bicycle, a processor of the display may calculate the current time.

However, a space inside the housing of the display needs to accommodate various components. There is a problem that in order to provide a space where the battery cell is located with certainty, the other components are restricted in terms of the positional arrangement thereof. In addition, the user may find it troublesome to replace the battery cell when the remaining capacity of the battery cell become zero.

It is desired that the display should display the current time even if the display does not include a built-in battery cell.

Example embodiments of the present invention disclose time display systems, driving systems, electrically assisted vehicles, battery packs, time display methods, and non-transitory computer readable media including computer programs as described below.

According to an example embodiment of the present invention a time display system for an electrically assisted vehicle includes a display and at least one processor configured or programmed to acquire time information representing information on time that is output by a battery pack that supplies electric power to an electric motor that generates drive power to cause the electrically assisted vehicle to travel, and cause the display to display current time based on the time information.

In a case of including a function to display the current time, the display of an electrically assisted vehicle conventionally includes a built-in battery cell such as a coin cell battery. The display includes such a built-in battery cell so that even in a state where the battery pack that supplies electric power to the electric motor is detached from the electrically assisted vehicle, the processor of the display may calculate the current time.

However, a space inside the housing of the display needs to accommodate various components. There is a problem that in order to provide a space where the battery cell is located, the other components are restricted in terms of the positional arrangement thereof. In addition, the user may find it troublesome to replace the battery cell when the remaining capacity of the battery cell become zero.

According to an example embodiment of the present invention, the at least one processor is configured or programmed to cause the display to display the current time based on the time information output by the battery pack. As a result, the display may display the current time even if the display does not include a built-in battery cell. This may improve the degree of freedom of the positional arrangement of the components of the display and may also make it unnecessary to replace the battery cell.

The battery pack may include a plurality of battery cells, and may keep on counting the time using the electric current output by the plurality of battery cells.

In the time display system above, the time information output by the battery pack represents current time.

With such a configuration, even if a processor other than the processor of the battery pack does not calculate the current time, the display is able to display the current time.

In the time display system above, the at least one processor is configured or programmed to acquire current time information representing the current time based on a current time setting operation performed by a user on the display, and output the current time information to the battery pack, and a processor of the battery pack is configured or programmed to set the current time based on the current time information output by the at least one processor.

With such a configuration, the current time may be set in the battery pack based on the current time set by the user.

In the time display system above, the at least one processor is configured or programmed to acquire current time information representing the current time based on a current time setting operation performed by a user on the display, and output the current time information to the battery pack, and a processor of the battery pack is configured or programmed to reset the current time to be calculated based on the current time information output by the at least one processor.

The current time calculated by the processor of the battery pack may occasionally be shifted little by little with the passage of time. The current time stored in the battery pack is reset to the current time set by the user so that the shifted current time stored in the battery pack may be corrected.

In the time display system above, the time information output by the battery pack represents a first value of time that is not the current time, and the at least one processor is configured or programmed to calculate the current time based on the first value and a second value that converts the first value into the current time.

With such a configuration, the current time may be calculated based on the time information representing the first value (e.g., the counted value) output by the battery pack.

In the time display system above, the time information output by the battery pack represents the second value.

With such a configuration, the current time may be calculated based on the information on the first value and on the second value output by the battery pack.

The time display system above may further include a storage to store information representing the second value, wherein the at least one processor is configured or programmed to read the information from the storage and calculate the current time based on the information representing the second value.

With such a configuration, the current time may be calculated based on the time information representing the first value output by the battery pack.

The time display system above may further include a storage to store table information representing a relationship between individual information of the battery pack and the second value, wherein the at least one processor is configured or programmed to acquire the individual information output by the battery pack, and acquire the second value to be used to calculate the current time based on the individual information and the table information.

With such a configuration, the second value may be acquired based on the individual information output by the battery pack.

In the time display system above, the first value is a counted value acquired by a processor of the battery pack configured or programmed to count time.

With such a configuration, the current time may be calculated based on the time information representing the counted value output by the battery pack.

In the time display system above, the second value is an offset value.

With such a configuration, the current time may be calculated based on the offset value.

In the time display system above, a processor of the battery pack is configured or programmed to output information representing the first value to the at least one processor, the at least one processor is configured or programmed to acquire current time information representing the current time based on a current time setting operation performed by a user on the display, calculate the second value based on the acquired current time information and the first value acquired from the battery pack, and output information representing the calculated second value to the battery pack, and the processor of the battery pack is configured or programmed to acquire the information from the at least one processor and set the second value to be used to calculate current time based on the information representing the second value.

With such a configuration, the second value (e.g., offset value) may be set in the battery pack based on the current time set by the user.

In the time display system above, a processor of the battery pack is configured or programmed to output information representing the first value to the at least one processor, the at least one processor is configured or programmed to acquire current time information representing the current time based on a current time setting operation performed by a user on the display, calculate the second value based on the current time information and the first value acquired from the battery pack, and output information representing the calculated second value to the battery pack, and the processor of the battery pack is configured or programmed to reset the second value to be used to calculate current time to the second value acquired from the at least one processor.

The current time calculated by the processor of the battery pack may occasionally be shifted little by little with the passage of time. The second value (e.g., offset value) stored in the battery pack is reset to the second value calculated by the at least one processor so that the shifted current time may be corrected.

In the time display system above, in a case where the time information cannot be acquired from the battery pack, the at least one processor is configured or programmed to not cause the display to display any current time.

With such a configuration, in the case where the time information cannot be acquired, the display may be caused not to display any current time.

In the time display system above, the battery pack is able to be charged by a charger, a processor of the charger is configured or programmed to output current time information representing the current time to the battery pack, and the processor of the battery pack is configured or programmed to set the current time based on the current time information output by the charger.

With such a configuration, the current time may be set in the battery pack based on the current time stored in the charger.

In the time display system above, the battery pack is able to be charged by a charger, a processor of the charger is configured or programmed to output current time information representing the current time to the battery pack, and the processor of the battery pack is configured or programmed to reset the current time to be calculated based on the current time information output by the charger.

The current time calculated by the processor of the battery pack may occasionally be shifted little by little with the passage of time. The current time stored in the battery pack is reset to the current time stored in the charger so that the shifted current time may be corrected.

In the time display system above, the battery pack is able to be charged by a charger, a processor of the battery pack is configured or programmed to output information representing the first value to the charger, a processor of the charger is configured or programmed to calculate the second value based on the current time and the first value acquired from the battery pack, and output information representing the calculated second value to the battery pack, and the processor of the battery pack is configured or programmed to acquire the second value from the charger and reset the second value to be used to calculate current time.

The current time calculated by the processor of the battery pack may occasionally be shifted little by little with the passage of time. The second value (e.g., offset value) stored in the battery pack is reset to the second value calculated by the charger so that the shifted current time may be corrected.

In the time display system above, the at least one processor is configured or programmed to acquire current time information representing the current time from an external device, and output the current time information to the battery pack, and a processor of the battery pack is configured or programmed to reset the current time to be calculated based on the current time information output by the at least one processor.

The current time calculated by the processor of the battery pack may occasionally be shifted little by little with the passage of time. The current time stored in the battery pack is reset to the current time acquired from the external device so that the shifted current time may be corrected.

In the time display system above, a processor of the battery pack is configured or programmed to output information representing the first value to the at least one processor, the at least one processor is configured or programmed to acquire current time information representing the current time from an external device, calculate the second value based on the current time information acquired from the external device and the first value acquired from the battery pack, and output the calculated second value to the battery pack, and the processor of the battery pack is configured or programmed to reset the second value to be used to calculate current time to the second value acquired from the at least one processor.

The current time calculated by the processor of the battery pack may occasionally be shifted little by little with the passage of time. The second value (e.g., offset value) stored in the battery pack is reset to the second value calculated by the at least one processor so that the shifted current time may be corrected.

The time display system above may further include a processor of the battery pack configured or programmed to acquire current time information representing the current time from an external device, and reset the current time to be calculated based on the current time information acquired from the external device.

The current time calculated by the processor of the battery pack may occasionally be shifted little by little with the passage of time. The current time stored in the battery pack is reset to the current time stored in the external device so that the shifted current time may be corrected.

The time display system above may further include a processor of the battery pack configured or programmed to output the first value to an external device, and a processor of the external device configured or programmed to calculate the second value based on the current time and the first value output by the battery pack, and output the calculated second value to the battery pack, wherein the processor of the battery pack is configured or programmed to reset the second value to be used to calculate current time to the second value output by the external device.

The current time calculated by the processor of the battery pack may occasionally be shifted little by little with the passage of time. The offset value stored in the battery pack is reset to the offset value calculated by the external device so that the shifted current time may be corrected.

In the time display system above, a plurality of the battery packs are mounted on the electrically assisted vehicle, and the at least one processor is configured or programmed to acquire the time information from one of the plurality of battery packs.

The time information in one battery pack is used so that even in the case where there is a difference in the current time among the plurality of battery packs, the display is able to display the current time with no processing error.

In the time display system above, a plurality of the battery packs are mounted on the electrically assisted vehicle, and in a case where the plurality of battery packs include a battery pack in which current time is set and a battery pack in which no current time is set, a processor of the battery pack in which no current time is set is configured or programmed to acquire current time information representing the current time from a processor of the battery pack in which the current time is set, and set the current time based on the current time information.

With such a configuration, the current time may be set in the battery pack in which no current time has been set.

In the time display system above, a plurality of the battery packs are mounted on the electrically assisted vehicle, and in a case where the plurality of battery packs include a battery pack in which current time is set and a battery pack in which no current time is set, the at least one processor is configured or programmed to acquire current time information representing the current time from a processor of the battery pack in which the current time is set, and output the acquired current time information to a processor of the battery pack in which no current time is set, and the processor of the battery pack in which no current time is set is configured or programmed to set the current time based on the current time information.

With such a configuration, the current time may be set in the battery pack in which no current time has been set.

In the time display system above, the at least one processor includes a processor in the display.

With such a configuration, the processor of the display may cause the display to display the current time based on the time information output by the battery pack.

According to an example embodiment of the present invention a driving system includes the time display system of any one of the example embodiments of the present invention described above.

With such a configuration, the driving system is provided in which the display is able to display the current time and does not need to include a built-in battery cell.

According to an example embodiment of the present invention, an electrically assisted vehicle includes the time display system of any one of the example embodiments of the present invention described above.

With such a configuration, the electrically assisted vehicle is provided in which the display is able to display the current time and does not need to include a built-in battery cell.

According to an example embodiment of the present invention, a time display method for causing a display of an electrically assisted vehicle to display current time, the time display method being executable by at least one computer, includes acquiring time information representing information on time that is output by a battery pack that supplies electric power to an electric motor that generates drive power to cause the electrically assisted vehicle to travel, and causing the display to display current time based on the time information.

In the case of including a function to display the current time, the display of the electrically assisted vehicle conventionally includes a built-in battery cell such as a coin cell battery. The display includes such a built-in battery cell so that even in a state where the battery pack that supplies electric power to the electric motor is detached from the electrically assisted vehicle, the processor of the display may calculate the current time.

However, a space inside the housing of the display needs to accommodate various components. There is a problem that in order to provide a space where the battery cell is located, the other components are restricted in terms of the positional arrangement thereof. In addition, the user may find it troublesome to replace the battery cell when the remaining capacity of the battery cell become zero.

According to an example embodiment of the present invention, the at least one processor is configured or programmed to cause the display to display the current time based on the time information output by the battery pack. As a result, the display may display the current time even if the display does not include a built-in battery cell. This may improve the degree of freedom of the positional arrangement of the components of the display and may also make it unnecessary to replace the battery cell.

The battery pack includes a plurality of battery cells, and may keep on counting the time using the electric current output by the plurality of battery cells.

According to an example embodiment of the present invention, a non-transitory computer readable medium including a computer program to cause at least one computer to execute a process of causing a display of an electrically assisted vehicle to display current time, the computer program causing the at least one computer to acquire time information representing information on time that is output by a battery pack that supplies electric power to an electric motor that generates drive power to cause the electrically assisted vehicle to travel, and cause the display to display current time based on the time information.

In a case of including a function to display the current time, the display of the electrically assisted vehicle conventionally includes a built-in battery cell such as a coin cell battery. The display includes such a built-in battery cell so that even in a state where the battery pack that supplies electric power to the electric motor is detached from the electrically assisted vehicle, the processor of the display may calculate the current time.

However, a space inside the housing of the display needs to accommodate various components. There is a problem that in order to provide a space where the battery cell is located, the other components are restricted in terms of the positional arrangement thereof. In addition, the user may find it troublesome to replace the battery cell when the remaining capacity of the battery cell become zero.

According to an example embodiment of the present invention, the at least one processor causes the display to display the current time based on the time information output by the battery pack. As a result, the display may display the current time even if the display does not include a built-in battery cell. This may improve the degree of freedom of the positional arrangement of the components of the display and may also make it unnecessary to replace the battery cell.

The battery pack includes a plurality of battery cells, and may keep on counting the time using the electric current output by the plurality of battery cells.

According to an example embodiment of the present invention, a battery pack to supply electric power to an electric motor of an electrically assisted vehicle includes a plurality of battery cells and a processor configured or programmed to calculate current time, wherein the processor is configured or programmed to output time information representing the current time to a processor configured or programmed to control a display of the electrically assisted vehicle.

With such a configuration, the display of the electrically assisted vehicle is able to display the current time without including a built-in battery cell.

According to an example embodiment of the present invention, at least one processor is configured or programmed to cause the display to display the current time based on the time information output by the battery pack. As a result, the display may display the current time even if the display does not include a built-in battery cell. This may improve the degree of freedom of the positional arrangement of the components of the display and may also make it unnecessary to replace the battery cell.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a right side view showing an electrically assisted bicycle according to an example embodiment of the present invention.

FIG. 2 is a plan view showing a front portion of the electrically assisted bicycle according to an example embodiment of the present invention.

FIG. 3 shows a display according to an example embodiment of the present invention.

FIG. 4 is a block diagram showing an example of hardware configuration of the display according to an example embodiment of the present invention.

FIG. 5 is a block diagram showing an example of hardware configuration of a battery pack according to an example embodiment of the present invention.

FIG. 6 is a block diagram showing an example of hardware configuration of a drive unit according to an example embodiment of the present invention.

FIG. 7 shows an example of operation of the battery pack and the display according to an example embodiment of the present invention.

FIG. 8 is a flowchart showing an example of operation of the battery pack and the display according to an example embodiment of the present invention.

FIG. 9 shows another example of operation of the battery pack and the display according to an example embodiment of the present invention.

FIG. 10 shows still another example of operation of the battery pack and the display according to an example embodiment of the present invention.

FIG. 11 shows an example of operation of the battery pack, the drive unit, and the display according to an example embodiment of the present invention.

FIG. 12 shows still another example of operation of the battery pack and the display according to an example embodiment of the present invention.

FIG. 13 shows an example of table information according to an example embodiment of the present invention.

FIG. 14 shows another example of operation of the battery pack, the drive unit, and the display according to an example embodiment of the present invention.

FIG. 15 shows still another example of operation of the battery pack, the drive unit, and the display according to an example embodiment of the present invention.

FIG. 16 shows how to detach the battery pack from the electrically assisted bicycle according to an example embodiment of the present invention.

FIG. 17 shows a charger according to an example embodiment of the present invention.

FIG. 18 shows how to charge the battery pack attached to the electrically assisted bicycle according to an example embodiment of the present invention.

FIG. 19 is a block diagram showing an example of hardware configuration of the charger according to an example embodiment of the present invention.

FIG. 20 shows a plurality of the battery packs to be mounted on the electrically assisted bicycle according to an example embodiment of the present invention.

### DETAILED DESCRIPTION OF THE EXAMPLE EMBODIMENTS

Hereinafter, example embodiments of the present invention will be described with reference to the drawings. In the description of the example embodiments, like elements will bear like reference signs, and overlapping descriptions will be omitted. In the drawings, letters F, Re, L, R, U and D respectively indicate front, rear, left, right, up and down. The “front-rear”, “left-right” and “up-down” directions regarding an electrically assisted bicycle respectively indicate front-rear, left-right and up-down directions for a user sitting on a seat (saddle) of the electrically assisted bicycle while facing a handle. In the following example embodiments, an electrically assisted bicycle will be described as an example of an electrically assisted vehicle, but electrically assisted vehicles according to example embodiments of the present disclosure are not limited to electrically assisted bicycles. An electrically assisted vehicle according to example embodiments of the present disclosure may be, for example, an electrically assisted wheelchair. The following example embodiments are merely illustrative, and do not limit the present invention in any way.

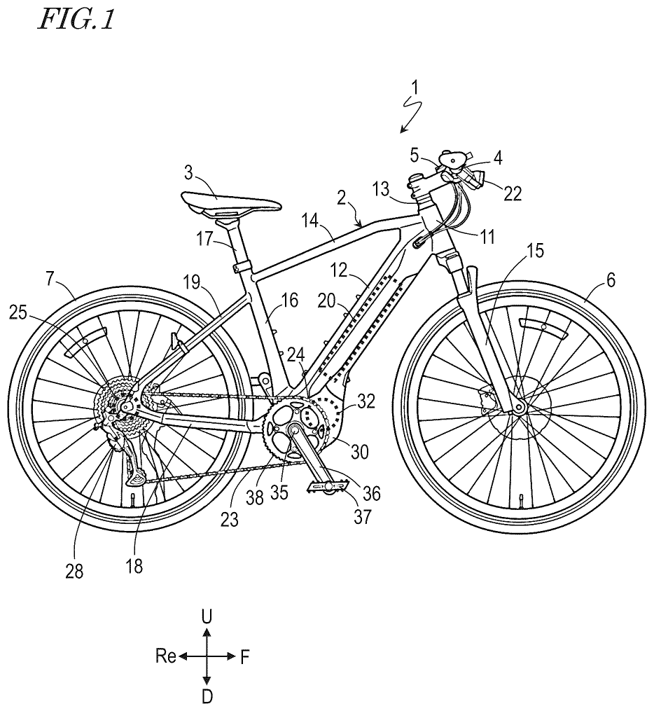

FIG. 1 is a right side view of an electrically assisted bicycle 1 according to an example embodiment of the present invention.

The electrically assisted bicycle 1 includes a body frame 2 extending in a front-rear direction. The body frame 2 includes a head pipe 11, a down tube 12, a top tube 14, a seat tube 16, a chain stay 18, a seat stay 19, and a bracket 24. The head pipe 11 is located at a front end of the body frame 2. A handle column 13 is rotatably inserted into the head pipe 11. A handle 4 is secured to the handle column 13. A meter unit 5 displaying various types of information on the electrically assisted bicycle 1 is provided on the handle 4. A head lamp 22 is located at the front of the handle 4.

A front fork 15 is secured to a bottom end of the handle column 13. A bottom end of the front fork 15 supports a front wheel 6, which is a steering wheel, such that the front wheel 6 is rotatable.

The down tube 12 extends obliquely rearward and downward from the head pipe 11. The seat tube 16 extends upward from a rear end of the down tube 12. The chain stay 18 extends rearward from a bottom end of the seat tube 16. The bracket 24 connects the rear end of the down tube 12, the bottom end of the seat tube 16 and a front end of the chain stay 18 to each other. The top tube 14 connects a top portion of the head pipe 11 and a top portion of the seat tube 16 to each other. A seat post 17 is inserted into the seat tube 16. The saddle 3, on which the user may sit, is provided at a top end of the seat post 17.

A rear end of the chain stay 18 supports a rear wheel 7, which is a driving wheel, such that the rear wheel 7 is rotatable. The seat stay 19 extends obliquely rearward and downward from the top portion of the seat tube 16. A bottom end of the seat stay 19 is connected with the rear end of the chain stay 18. A transmission 28 to change the transmission ratio is provided at the rear end of the chain stay 18. The transmission 28 may be provided in the vicinity of a pedal crankshaft 35. A speed sensor 25, which detects the rotation rate of the rear wheel 7, is provided on a rear portion of the chain stay 18. The speed sensor 25 may be provided on a bottom portion of the front fork 15 to detect the rotation rate of the front wheel 6.

A drive unit 30 is provided on the bracket 24 located in the vicinity of a position, in the body frame 2, that is the center of the vehicle (i.e., the electrically assisted bicycle 1). A housing of the drive unit 30 accommodates an electric motor 32, an MCU (motor control unit), a decelerator, and the like. The pedal crankshaft 35 is supported by extending through the drive unit 20 in a left-right direction. Crankarms 36 are respectively provided at both of two ends of the pedal crankshaft 35. Pedals 37 are rotatably provided respectively at tips of the crankarms 36.

A battery pack 20 to supply electric power to the drive unit 30 or the like is mounted on the down tube 12. In the example shown in FIG. 1, the battery pack 20 is provided inside the down tube 12. The down tube 12 may be hollow. At least a portion of the down tube 12 may have a U-shaped cross-section, and the down tube 12 may be provided with a cover to cover the U-shaped portion.

The battery pack 20 may be located on an outer surface of the down tube 12. The battery pack 20 may be mounted on the bracket 24 or the seat tube 16. The battery pack 20 is attachable to, and detachable from, the electrically assisted bicycle 1.

The battery pack 20 includes a plurality of battery cells and a BMS (battery management system). The plurality of battery cells included in the battery pack 20 are rechargeable batteries. The BMS controls charge/discharge of the battery pack 20, and monitors an output current, a battery remaining capacity and the like of the battery pack 20.

The MCU of the drive unit 30 controls operations of the electric motor 32, and also controls operations of various components of the electrically assisted bicycle 1. The MCU includes a semiconductor integrated circuit such as a processor or the like and a motor driving circuit. A rotation of the pedal crank shaft 35 generated by the user stepping on the pedals 37 is conveyed to the rear wheel 7 via a driving sprocket 38 and a chain 23. The MCU controls the electric motor 32 to generate a driving assisting output corresponding to the rotation output of the pedal crank shaft 35 generated by the user stepping on the pedals 37. Assist power generated by the electric motor 32 is conveyed to the rear wheel 7 via the driving sprocket 38 and the chain 23. Instead of the chain 23, a belt, a shaft or the like may be used.

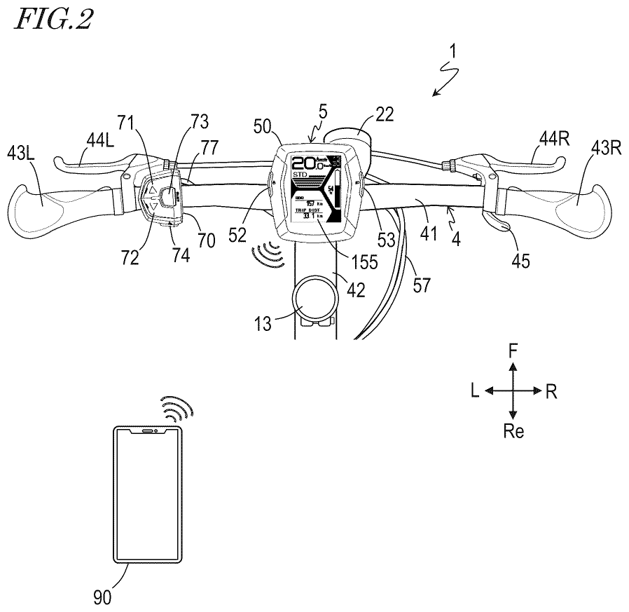

FIG. 2 is a top view showing a front portion of the electrically assisted bicycle 1. The handle 4 includes a handle bar 41. A right grip 43R is provided at a right end of the handle bar 41. A left grip 43L is provided at a left end of the handle bar 41. The user grips the right grip 43R and the left grip 43L with his/her hands to steer the electrically assisted bicycle 1.

A front wheel brake lever 44R and a shift controller 45 are provided in the vicinity of the right grip 43R. A rear wheel brake lever 44L is provided in the vicinity of the left grip 43L. When the right grip 43R and the front wheel brake lever 44R are gripped by the right hand of the user, braking power is supplied to the front wheel 6. When the left grip 43L and the rear wheel brake lever 44L are gripped by the left hand of the user, braking power is supplied to the rear wheel 7. The brake lever provided to the left of the handle bar 41 may be the front wheel brake lever supplying the front wheel 6 with the braking power, and the brake lever provided to the right of the handle bar 41 may be the rear wheel brake lever supplying the rear wheel 7 with the braking power. The shift controller 45 is referred to also as a “shifter”. The user may switch the transmission ratio by operating the shift controller 45.

The handle bar 41 is provided with the meter unit 5. The meter unit 5 includes a display 50 and an operation device 70. The display 50 may occasionally be referred to as a “meter”. The meter unit 5 may be supplied with electric power for operations thereof from the battery pack 20.

The display 50 displays various types of information on the electrically assisted bicycle 1. The display 50 is attached to the handle bar 41 or a handle stem 42 using an attachment tool such as a clamp or the like.

The operation device 70 is provided in the vicinity of, for example, the left grip 43L of the handle 4. The operation device 70 is attached to the handle bar 41 using an attachment tool such as a clamp or the like. The user may operate the operation device 70 with his/her fingers to perform an operation of, for example, setting the level of the assist power of the electric motor 32. The display 50 and the operation device 70 are electrically connected with each other via an electric cable 77. A signal in correspondence with an operation made by the user is sent from the operation device 70 to the display 50 via the electric cable 77. The display 50 and the MCU of the drive unit 30 (see FIG. 1) may transfer signals to each other via an electric cable 57. The display 50 and the operation device 70 may transfer signals to each other wirelessly. The display 50 and the MCU may transfer signals to each other wirelessly.

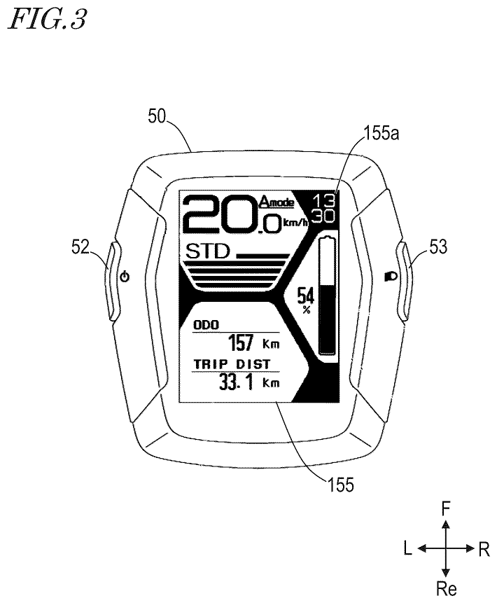

FIG. 3 shows the display 50. The display 50 includes a display panel 155 to display various types of information on the electrically assisted bicycle 1 and a plurality of switches 52 and 53 to accept operations of the user. The plurality of switches 52 and 53 are, for example, a power switch 52 and a lamp light switch 53. In this example embodiment, these switches are push-button switches, which are pushed down by the user with his/her finger to be turned on or off.

The power switch 52 turns on or off the power of the electrically assisted bicycle 1. When the power of the electrically assisted bicycle 1 is on, the drive unit 30 operates, whereas when the power of the electrically assisted bicycle 1 is off, the drive unit 30 does not operate. When the user pushes down the power switch 52 while the power is off, the power is turned on. When the user pushes down the power switch 52 while the power is on, the power is turned off.

The lamp light switch 53 turns the head lamp 22 (FIG. 1) on or off. When the user pushes down the lamp light switch 53 while the head lamp 22 is off to turn the head lamp 22 on, the head lamp 22 emits light and may illuminate the road ahead of the electrically assisted bicycle 1. When the user pushes down the lamp light switch 53 while the head lamp 22 is on, the head lamp 22 is turned off.

The display panel 155 includes, for example, a liquid crystal panel. The display panel 155 may display various types of information such as the traveling speed, the traveling distance, the battery remaining capacity, the assist mode, the current time, and the like. The display panel 155 may display such information by a segment system or by a dot-matrix system. A display panel other than the liquid crystal panel, for example, an OLED (Organic Light-Emitting Diode) panel or an electronic paper panel may be used.

The operation device 70 includes assist power setting switches 71 and 72, a select switch 73, and a walk switch 74. The assist power setting switches 71 and 72 set the assist power of the electric motor 32. In this example embodiment, the electrically assisted bicycle 1 may be set to any one of a plurality of assist modes. The plurality of assist modes include, for example, an assist-free mode, an ecological mode, a smart mode, and a high mode, in the order from the mode in which the magnitude of the assist power assisting the power of a human body is lowest. In the assist-free mode, the electric motor 32 does not generate any assist power. When the user pushes down the assist power setting switch 71, an assist mode in which the magnitude of the assist power assisting the power of a human body is relatively low is switched to an assist mode in which such a magnitude is relatively higher. When the user pushes down the assist power setting switch 72, an assist mode in which the magnitude of the assist power assisting the power of a human body is relatively higher is switched to an assist mode in which such a magnitude is relatively lower.

In the above-described example, there are four different assist modes. Alternatively, there may be three or less assist modes, or five or more assist modes. For example, there may be an assist mode in which larger assist power than that in the high mode is generated, or there may be a plurality of different types of ecological modes.

The select switch 73 switches the display contents of the display panel 155. The user may push down the select switch 73 to switch the display contents of the display panel 155.

The walk switch 74 accepts, from the user, an instruction to execute a walk mode. In the walk mode, while the user is walking the electrically assisted bicycle 1, the electric motor 32 is caused to generate assist power. The expression “walking the electrically assisted bicycle 1” refers to user pushing and moving the bicycle 1 forward without stepping on the pedals 37. In an example of operation of “walking the electrically assisted bicycle 1”, the user gets off the bicycle 1 and moves the bicycle 1 forward while walking and pushing the handle 4 with his/her hands.

When the user keeps pushing down the walk switch 74 while walking the electrically assisted bicycle 1, the electric motor 32 generates assist power. The electric motor 32 is caused to generate assist power while the user is walking the electrically assisted bicycle 1 so that the load on the user may be decreased. For example, when the user is walking up a slope while pushing the bicycle 1 with his/her hands, the load on the user may be decreased.

The meter 50 is wirelessly communicable with a mobile terminal device 90. The mobile terminal device 90 is, for example, a smartphone or a tablet computer. The mobile terminal device 90 may be a wearable computer such as a smart watch, smart glass or the like. Such wireless communication allows the display 50 and the mobile terminal device 90 to transfer various types of information to each other. The display 50 and the mobile terminal device 90 may perform wired communication with each other.

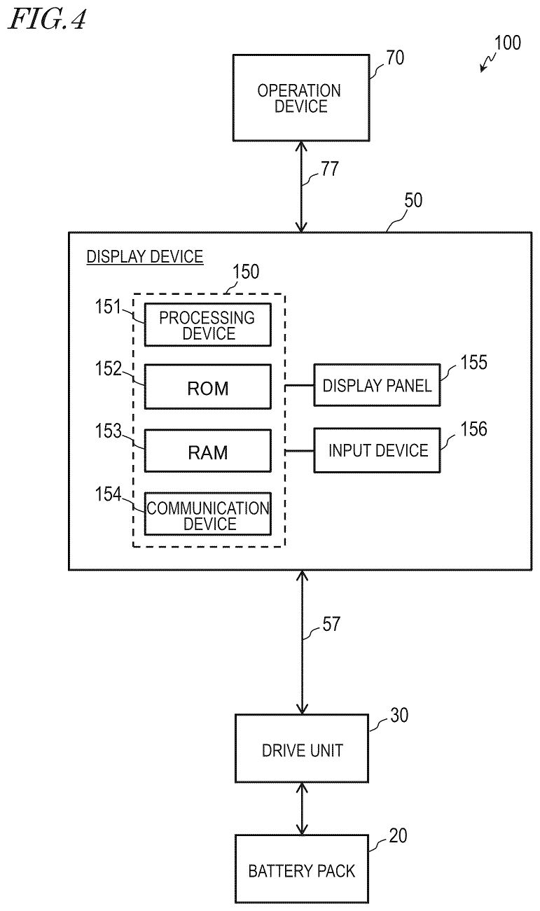

Now, an example of a hardware configuration of the display 50 will be described. FIG. 4 is a block diagram showing an example of a hardware configuration of the display 50.

A driving system 100 according to this example embodiment includes the drive unit 30, the display 50, the operation device 70, and the battery pack 20. The display 50 includes a controller 150, the display panel 155, and an input device 156. These components are communicably connected with each other via a bus.

The controller 150 includes a processor 151, storage mediums such as a ROM (Read Only Memory) 152, a RAM (Random Access Memory) 153 and the like, and a communication device 154. The ROM 152 may store a computer program (or firmware) to cause the processor 151 to execute processes. The computer program may be stored on the ROM 152 at the time of production of the display 50. The computer program may be provided to the display 50 via a storage medium (e.g., a semiconductor memory, an optical disc or the like) or an electric communication line (e.g., the Internet). Such a computer program may be marketed as commercial software.

The processor 151 may be a semiconductor integrated circuit such as a processor or the like, and includes, for example, a central processing unit (CPU). The processor 151 may include a microprocessor or a microcontroller. The processor 151 consecutively executes a computer program describing a group of commands to execute various processes (computer program stored on the ROM 152) to perform a desired process.

The processor 151 may be an FPGA (Field Programmable Gate Array), a GPU (Graphics Processing Unit), an ASIC (Application Specific Integrated Circuit) or an ASSP (Application Specific Standard Product) each including a CPU, or a combination of two or more circuits selected from these circuits.

The ROM 152 includes, for example, a writable memory (e.g., PROM), a rewritable memory (e.g., flash memory), or a memory from which data can be read but to which data cannot be written. As described above, the ROM 152 may store a computer program to cause the processor 151 to execute processes. The ROM 152 further stores a computer program to control operations of the processor 151. The ROM 152 does not need to be a single storage medium, and may be an assembly of a plurality of storage mediums. A portion of the assembly of the plurality of storage memories may be a detachable memory.

The RAM 153 provides a work area in which the computer program stored on the ROM 152 is once developed at the time of booting. The RAM 153 does not need to be a single storage medium, and may be an assembly of a plurality of storage mediums.

The communication device 154 is a communication module that communicates with the battery pack 20, the drive unit 30, the mobile terminal device 90 or the like. The communication device 154 may perform wired communication and/or wireless communication. The communication device 154 may perform wired communication in compliance with a communication protocol such as, for example, USB, IEEE1394 (registered trademark), Ethernet (registered trademark) or the like. The communication device 154 may perform wireless communication in compliance with, for example, a Bluetooth (registered trademark) and/or Wi-Fi (registered trademark) protocol. Any of the protocols includes a wireless communication protocol using the frequencies of the 2.4 GHz band or the 5.0 GHz band. The communication device 154 may be a communication module capable of performing wireless communication in compliance with a communication system of BLE (Bluetooth Low Energy) or LPWA (Low Power Wide Area). The communication device 154 may perform wireless communication using a mobile telephone line or a line transmitting information via an artificial satellite.

The input device 156 accepts an operation made by the user on the power switch 52, the lamp light switch 53 or the like described above. The display 50 may include a touch panel and/or a microphone as the input device 156.

The processor 151 detects that any of various switches of the display 50 and the operation device 70 has been pressed, or controls operations of the display panel 155. For example, when the user starts pressing a switch, the processor 151 detects a voltage value and/or a current value equal to, or higher than, a predetermined value. When the user stops pressing the switch, the processor 151 detects that the voltage value and/or the current value that has been detected so far is now, for example, zero. The processor 151 may detect, in parallel, a plurality of switches being pressed.

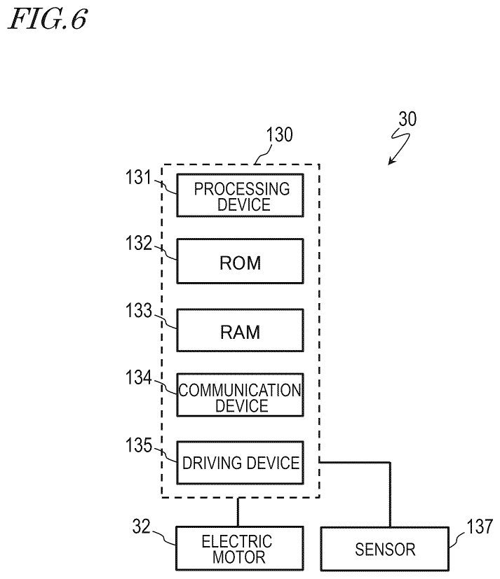

In response to any of various switches of the display 50 and the operation device 70 being pressed, the processor 151 performs a control to change the display contents of the display panel 155. The processor 151 outputs a signal in accordance with the switch being pressed to the MCU (represented with reference numeral 130 in FIG. 6) of the drive unit 30. For example, the processor 151 outputs a signal representing a selected assist mode to the MCU 130. Upon receipt of the signal, the MCU 130 performs a control to cause the electric motor 32 to generate an assist power in accordance with the selected assist mode.

An output signal from the speed sensor 25 (FIG. 1) is input to the MCU 130 of the drive unit 30. The MCU 130 may calculate the traveling speed of the electrically assisted bicycle 1 based on an output signal from the speed sensor 25. The MCU 130 outputs traveling speed information representing the traveling speed to the display 50. Upon receipt of the traveling speed information, the processor 151 performs a control to cause the display panel 155 to display the traveling speed. The output signal from the speed sensor 25 may be directly input to the display 50 without being once output to the MCU 130.

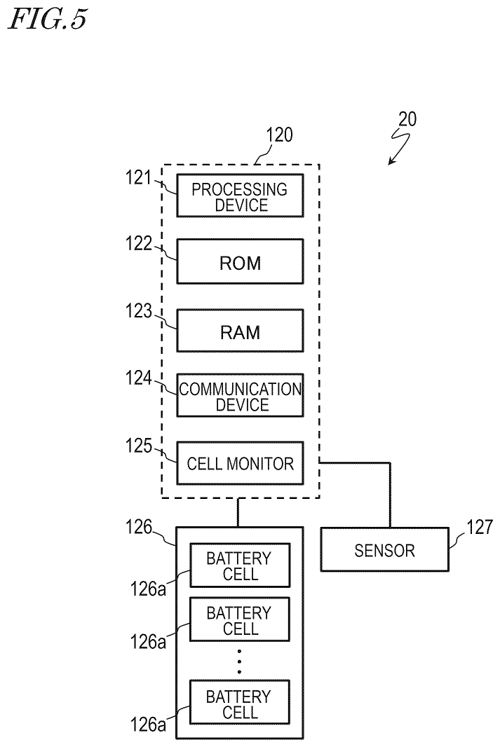

The BMS 120 (represented with reference numeral 120 in FIG. 5) of the battery pack 20 controls various operations of the battery pack 20 such as charge/discharge, and monitors various states of the battery pack 20. The BMS 120 monitors the voltage, the current, the temperature, the SOC (State of Charge) and the like of the battery pack 20. The MCU 130 and the BMS 120 transfer necessary information to each other. The MCU 130 receives battery information representing the voltage, the current, the temperature, the SOC and the like of the battery pack 20 from the BMS 120.

The MCU 130 outputs SOC information representing the SOC of the battery pack 20 to the display 50. The processor 151 controls the display of the display panel 155 regarding the battery remaining capacity in accordance with the battery remaining capacity calculated by the processor 151 based on the SOC information.

FIG. 5 is a block diagram showing an example of a hardware configuration of the battery pack 20.

The battery pack 20 includes the BMS 120, a battery module 126, and a sensor 127. The BMS 120 includes a processor 121, a ROM 122, a RAM 123, a communication device 124 and a cell monitor 125. The configurations of the processor 121, the ROM 122 and the RAM 123 are substantially the same as those of the processor 151, the ROM 152 and the RAM 153 of the display 50 and will not be described.

The ROM 122 stores a computer program (or firmware) to cause the processor 121 to execute processes. The computer program may be stored on the ROM 122 at the time of production of the battery pack 20. The computer program may be provided to the battery pack 20 via a storage medium or an electric communication line. Such a computer program may be marketed as commercial software. The processor 121 consecutively executes a computer program describing a group of commands to execute various processes (computer program stored on the ROM 122) to perform a desired process. The processor 121 controls operations of the battery pack 20 such as, for example, operations of charging and discharging the battery pack 20, and monitors an output current, an output voltage, a remaining capacity and the like of the battery pack 20.

The battery pack 20 may include any number of battery module(s) 126. One or more battery modules 126 are included in the battery pack 20. The battery modules 126 each include a plurality of battery cells 126a. Each of the battery modules 126 may include any number of battery cells 126a.

The sensor 127 may be a current sensor to detect the current of the battery pack 20, a voltage sensor to detect the voltage of the battery pack 20, a temperature sensor to detect the temperature of the battery pack 20, or the like. The cell monitor 125 monitors the current, the voltage, the temperature or the like of the battery pack 20 based on an output signal from the sensor 127. The cell monitor 125 outputs information representing the current, the voltage, the temperature or the like to the processor 121. The sensor 127 may detect the current, the voltage, the temperature or the like of each of the battery modules 126.

The communication device 124 is a communication module for wired communication with the drive unit 30. The communication may be performed by a communication system such as, for example, a CAN (Controller Area Network) or the like. The communication device 124 may perform wireless communication with the drive unit 30. The communication device 124 may perform wired communication or wireless communication with the display 50.

FIG. 6 is a block diagram showing an example of a hardware configuration of the drive unit 30.

The drive unit 30 includes the MCU 130, the electric motor 32, and a sensor 137. The MCU 130 includes a processor 131, a ROM 132, a RAM 133, a communication device 134, and a driving device 135. The configurations of the processor 131, the ROM 132 and the RAM 133 are substantially the same as those of the processor 151, the ROM 152 and the RAM 153 of the display 50 and will not be described.

The ROM 132 stores a computer program (or firmware) to cause the processor 131 to execute processes. The computer program may be stored on the ROM 132 at the time of production of the drive unit 30. The computer program may be provided to the drive unit 30 via a storage medium or an electric communication line. Such a computer program may be marketed as commercial software. The processor 131 consecutively executes a computer program describing a group of commands to execute various processes (computer program stored on the ROM 132) to perform a desired process. The processor 131 controls operations of the drive unit 30.

The driving device 135 includes a power source circuit that outputs electric power that drives the electric motor 32. The power source circuit includes, for example, a smoothing circuit smoothing a direct voltage that is output by the battery pack 20, an inverter circuit generating a motor driving current, and the like.

The sensor 137 is a torque sensor to detect a torque generated to rotation shafts including the pedal crank shaft 35, a rotation sensor to detect the rotation of the electric motor 32, or the like. The processor 131 controls operations of the driving device 135 based on an output signal from the sensor 137.

The processor 131 controls the driving device 135 such that the electric motor 32 generates assist power in accordance with the magnitude of the torque detected by the torque sensor. The driving device 135 generates and outputs a motor driving current that drives the electric motor 32. The electric motor 32 supplied with the motor driving current is rotated and generates the assist power. The assist power generated by the electric motor 32 is conveyed to the driving sprocket 38 (FIG. 1) via the decelerator or the like. The rotation of the driving sprocket 38 is conveyed to the rear wheel 7 via the chain 23.

The communication device 134 is a communication module for wired communication with the battery pack 20 and the display 50. The communication may be performed by a communication system such as, for example, a CAN or the like. The communication device 134 may perform wireless communication with the battery pack 20 and/or the display 50.

Now, a time display system 10 to cause the display 50 to display current time will be described.

In this example embodiment, the battery pack 20 outputs time information representing information on the time to the display 50, and the display 50 displays current time based on the time information received from the battery pack 20.

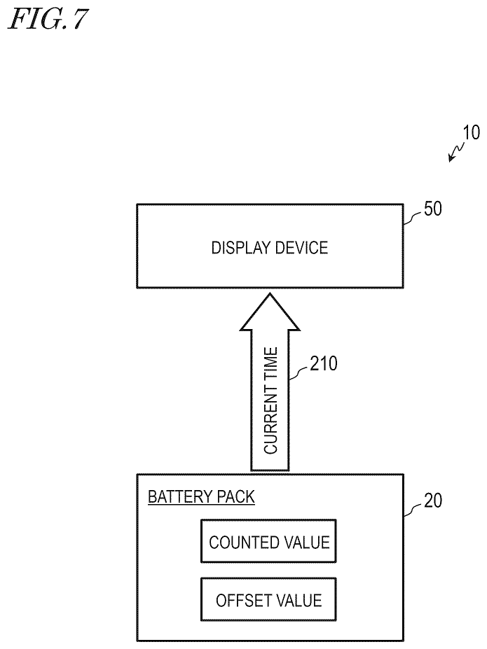

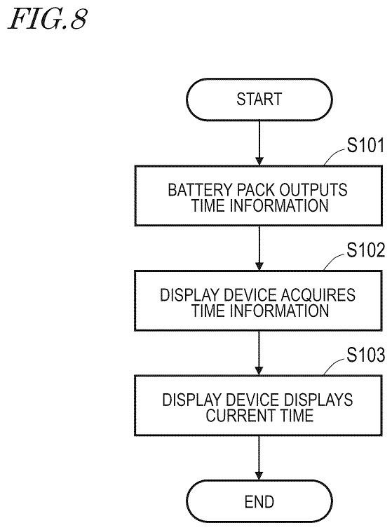

FIG. 7 shows an example of operation of the battery pack 20 and the display 50. FIG. 8 is a flowchart showing an example of operation of the battery pack 20 and the display 50.

The time display system 10 includes at least the display 50. In the example shown in FIG. 7, the time display system 10 includes the display 50 and the battery pack 20. The time display system 10 may include the drive unit 30.

The transfer of information between the display 50 and the battery pack 20 may be performed via the drive unit 30. The MCU 130 of the drive unit 30 outputs information received from the display 50 to the battery pack 20, and outputs information received from the battery pack 20 to the display 50. Such transfer of the information via the drive unit 30 is encompassed in the transfer of the information between the display 50 and the battery pack 20. The display 50 and the battery pack 20 may directly transfer information to each other.

The processor 151 (FIG. 4) of the display 50 transfers information as described above via the communication device 154. The processor 121 (FIG. 5) of the battery pack 20 transfers information as described above via the communication device 124. The processor 131 (FIG. 6) of the drive unit 30 transfers information as described above via the communication device 134.

In the example shown in FIG. 7, the processor 121 of the battery pack 20 calculates current time.

The processor 121 may calculate the current time by any appropriate method. For example, the processor 121 includes a real time clock (RTC) and continuously counts the time. The RTC may be realized by hardware and/or software. The processor 121 counts the time to acquire a counted value (first value). The ROM 122 of the battery pack 20 stores an offset value (second value) for conversion of the counted value that is not the current time into the current time. The processor 121 may calculate the current time based on the counted value and the offset value.

According to an exemplary method for counting the time, the time is counted based on the coordinated universal time (UTC).

In the case where the processor 121 of the battery pack 20 produced in a plant starts counting the time from, for example, “11:00:00 (hour:minute:second) of the 1st of February 2023”, the offset value is “1675249200” seconds. The offset value is stored on the ROM 122 of the battery pack 20.

In this case, for example, the counted value at “13:30:00 (hour:minute:second) of the 1st of December 2023” is “26188200” seconds. This counted value and the offset value are added together to provide an epoch second count of “1701437400”. The epoch second count is referred to also as the “UNIX (registered trademark) second”. The epoch second count represents the number of seconds from 0:0:0 (hour:minute:second) of the 1st of January 1970. This epoch second count may be used to calculate the current time.

In the case where a time zone is set, the time difference from the UTC may be further calculated to provide the current time of the set time zone. For example, the Japan Standard Time is represented by the time ahead of the UTC by 9 hours, that is, (UTC+9). Nine hours equals 32400 seconds. 32400 seconds may be added to the above-mentioned epoch second count to acquire the epoch second count corresponding to the Japan Standard Time. Nine hours may be added to the current time of the UTC to acquire the current time of the Japan Standard Time.

The processor 121 of the battery pack 20 counts the time by, for example, the above-described method, and calculates the current time based on the counted value and the offset value. The above-described method for counting the time is one example, and any other appropriate method may be used.

The processor 121 outputs time information 210 representing the calculated current time to the display 50 (step S101 in FIG. 8). The time information 210 may include information on the year/month/day.

The processor 151 of the display 50 receives the time information 210 (step S102), and causes the display panel 155 to display the current time represented by the time information 210 (step S103).

In the example shown in FIG. 3, the current time “13:30” (hour:minute) is displayed in a top right area 155a of the display panel 155. Any appropriate method may be used to display the current time, and the current time may be displayed at any position of the display panel 155 with any shape. The display panel 155 may display the year/month/day together with the current time.

In this example embodiment, the display 50 displays the current time based on the time information 210 output by the battery pack 20. As a result, the display 50 may display the current time even if the display 50 does not include a built-in battery cell. This may improve the degree of freedom of the positional arrangement of the components of the display 50 and may also make it unnecessary to replace the battery cell.

It should be noted that there is an example embodiment in which a device other than the display 50 (e.g., a communication unit) includes a built-in battery cell for calculating the current time. Even in a modified example embodiment where such a device other than the display 50 is configured not to include the built-in battery cell, the present invention enables the display 50 to display the current time.

The battery pack 20 includes the plurality of battery cells 126 (FIG. 5), which supply electric power to the electric motor 32. The processor 121 of the battery pack 20 may keep on counting the time using the electric power that is output by the plurality of battery cells 126 included in the battery pack 20.

The battery pack 20 may output the time information 210 when being requested by the display 50 or may automatically start outputting the time information 210 when the power of the electrically assisted bicycle 1 is turned on.

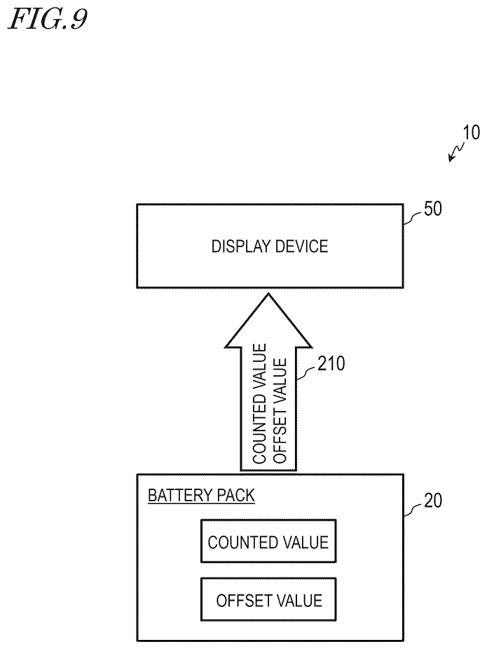

FIG. 9 shows another example of operation of the battery pack 20 and the display 50.

In the example shown in FIG. 9, the processor 121 of the battery pack 20 outputs time information 210, not representing the current time but representing a counted value and an offset value, to the display 50. In this example, the processor 151 of the display 50 calculates current time based on the counted value and the offset value represented by the time information 210. The processor 151 may, for example, calculate the current time using the above-described method used by the processor 121 to calculate the current time. The processor 151 may cause the display panel 155 to display the calculated current time and thus display the current time.

In the example embodiment in which the battery pack 20 does not output the time information 210 representing the current time, the processor 121 of the battery pack 20 does not need to calculate the current time.

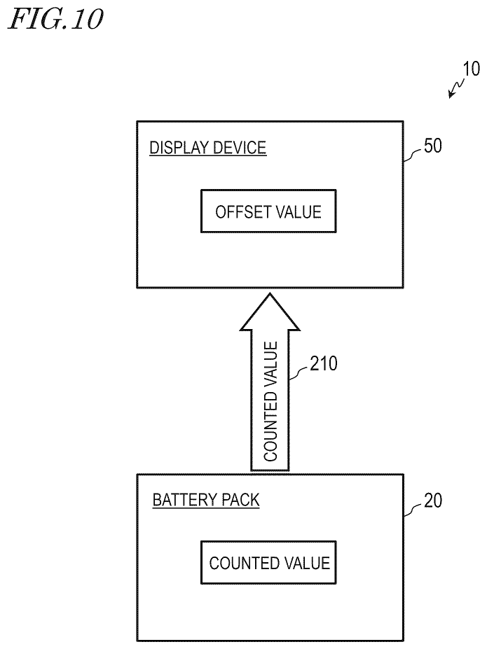

FIG. 10 shows still another example of operation of the battery pack 20 and the display 50.

In the example shown in FIG. 10, the ROM 152 of the display 50 stores an offset value in advance. The processor 121 of the battery pack 20 outputs time information 210 representing a counted value to the display 50. In this example, the processor 151 of the display 50 calculates current time based on the counted value represented by the time information 210 and the offset value read from the ROM 152. The processor 151 may cause the display panel 155 to display the calculated current time and thus display the current time.

Now, setting of the current time in the battery pack 20 will be described. The current time in the battery pack 20 may be set by the user. For example, the user may operate a plurality of switches of the display 50 and/or the operation device 70 to set the current time. The processor 151 of the display 50 outputs current time information, representing the current time set by the user, to the battery pack 20. The current time information may include information on the year/month/day set by the user. The processor 121 of the battery pack 20 may set current time based on the received current time information.

The processor 121 calculates an offset value based on the current counted value and the current time, and stores the calculated offset value on the ROM 122. The processor 121 may calculate the current time based on the calculated offset value and the counted value. In the case where no current time is set in the battery pack 20, the calculation of the current time may be started based on the calculated offset value.

In the case where current time is already set in the battery pack 20, the processor 121 may reset the current time based on the current time information received from the display 50. The current time calculated by the processor 121 may occasionally be shifted little by little with the passage of time. The current time stored in the battery pack 20 is reset to the current time set by the user so that the shifted current time stored in the battery pack 20 may be corrected.

The display 50 may acquire current time information representing current time from an external device to set the current time in the battery pack 20. The external device may be, for example, the mobile terminal device 90, a personal computer, or another electric device. For example, the mobile terminal device 90 outputs the current time information to the display 50. The processor 151 of the display 50 outputs the current time information to the battery pack 20. The processor 121 of the battery pack 20 may set current time based on the received current time information. In the case where current time is already set in the battery pack 20, the processor 121 may reset the current time based on the current time information received from the display 50.

The offset value may be calculated by the processor 151 of the display 50. In this case, the processor 121 of the battery pack 20 outputs time information 210 representing a counted value to the display 50. The processor 151 acquires the current time information representing the current time set by the user or the current time information output by the external device by the above-described method.

The processor 151 calculates an offset value based on the acquired current time information and the acquired counted value. The processor 151 outputs information representing the calculated offset value to the battery pack 20. The processor 121 of the battery pack 20 may set an offset value based on the acquired information representing the offset value. In the case where an offset value is already set in the battery pack 20, the processor 121 may reset the offset value based on the information received from the display 50.

In the case where the time information 210 cannot be acquired from the battery pack 20, the processor 151 does not cause the display panel 155 to display any current time. In the case where, for example, the battery pack 20 is of a model that does not output the time information 210, the processor 151 cannot acquire the time information 210 from the battery pack 20, and therefore, does not display any current time. In this case, the processor 151 may cause the display panel 155 to display information indicating that the current time cannot be displayed.

In the above-described example shown in FIG. 10, the ROM 152 of the display 50 stores the offset value in advance. The offset value may be stored on the ROM 132 of the drive unit 30 in advance.

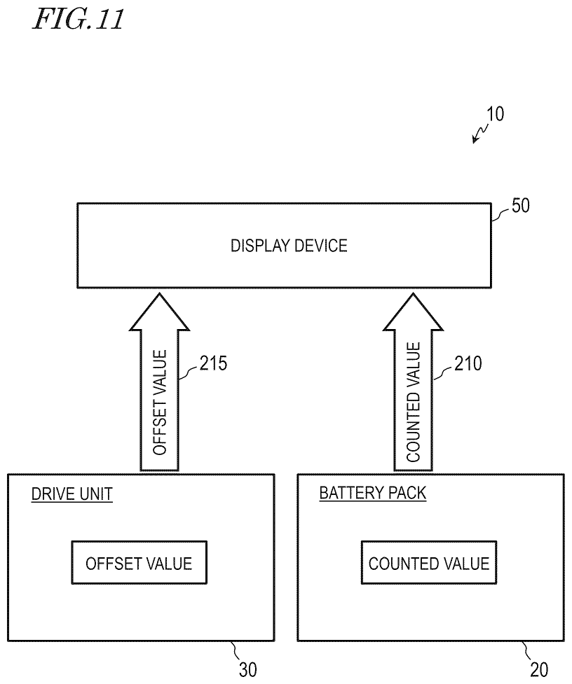

FIG. 11 shows an example of operation of the battery pack 20, the drive unit 30 and the display 50.

In the example shown in FIG. 11, the ROM 132 of the drive unit 130 stores an offset value in advance. The processor 121 of the battery pack 20 outputs time information 210 representing a counted value to the display 50. The processor 131 of the drive unit 30 outputs offset value information 215 representing the offset value to the display 50.

In this example, the processor 151 of the display 50 calculates current time based on the counted value represented by the time information 210 and the offset value represented by the offset value information 215. The processor 151 may cause the display panel 155 to display the calculated current time and thus display the current time.

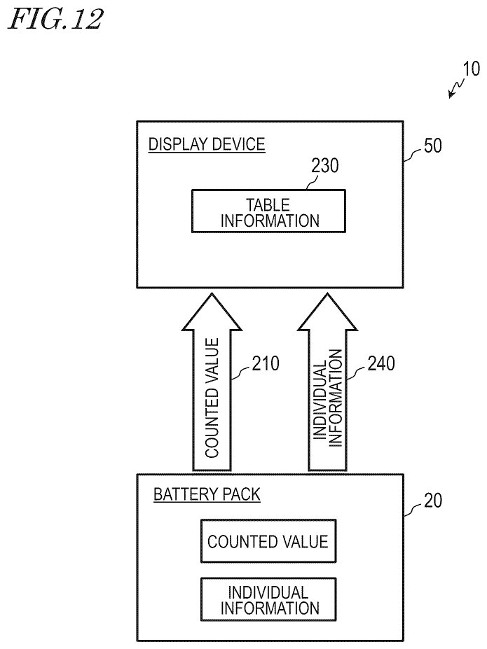

FIG. 12 shows still another example of operation of the battery pack 20 and the display 50.

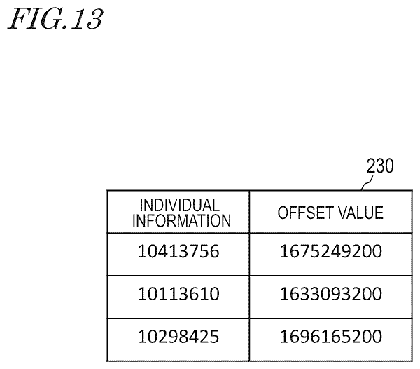

In the example shown in FIG. 12, the ROM 152 of the display 50 stores table information 230. FIG. 13 shows an example of the table information 230. The table information 230 shows the relationship between individual information on the battery pack 20 and the offset value. The individual information is information to uniquely identify the battery pack 20. The individual information represents, for example, an identification number.

The ROM 122 of the battery pack 20 stores the individual information for identification of the battery pack 20 itself. The processor 121 of the battery pack 20 outputs time information 210 representing a counted value and the individual information 240 to the display 50.

The processor 151 of the display 50 acquires the time information 210 and the individual information 240 output by the battery pack 20. The processor 151 acquires an offset value corresponding to the individual information 240 based on the table information 230. The processor 151 calculates current time based on the counted value represented by the time information 210 and the offset value acquired from the table information 230. The processor 151 may cause the display panel 155 to display the calculated current time and thus display the current time.

In the case where the table information 230 does not include the individual information 240 output by the battery pack 20, the processor 151 cannot acquire the offset value and does not display any current time. In this case, the processor 151 may cause the display panel 155 to display information indicating that the current time cannot be displayed.

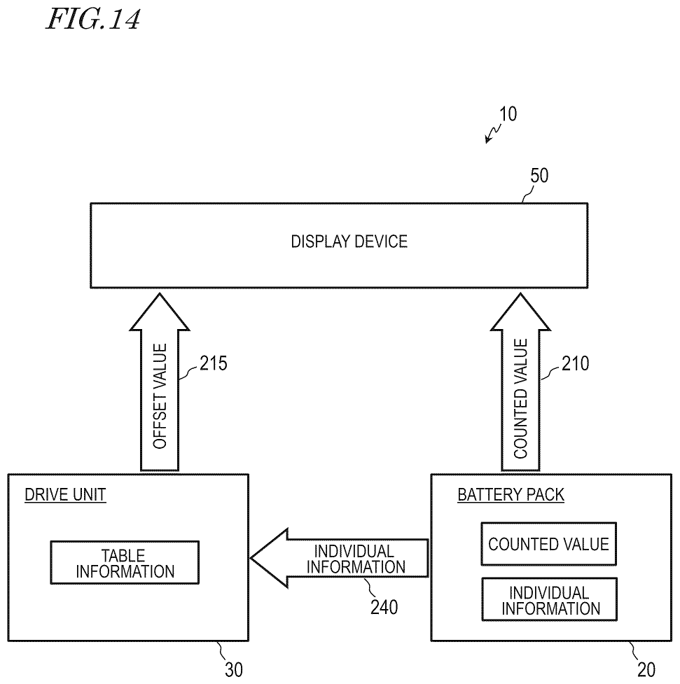

FIG. 14 shows another example of operation of the battery pack 20, the drive unit 30 and the display 50.

In the example shown in FIG. 14, the ROM 132 of the drive unit 30 stores the table information 230. The table information 230 shows the relationship between the individual information on the battery pack 20 and the offset value.

The processor 121 of the battery pack 20 outputs time information 210 representing a counted value to the display 50 and outputs the individual information 240 to the drive unit 30.

The processor 131 of the drive unit 30 acquires the individual information 240 output by the battery pack 20. The processor 131 acquires an offset value corresponding to the individual information 240 based on the table information 230. The processor 131 outputs offset value information 215 representing the offset value to the display 50.

The processor 151 of the display 50 calculates current time based on the counted value represented by the time information 210 and the offset value represented by the offset value information 215. The processor 151 may cause the display panel 155 to display the calculated current time and thus display the current time.

The ROM 132 of the drive unit 30 stores the table information 230 so that the ROM 152 of the display 50 does not need to store the table information 230.

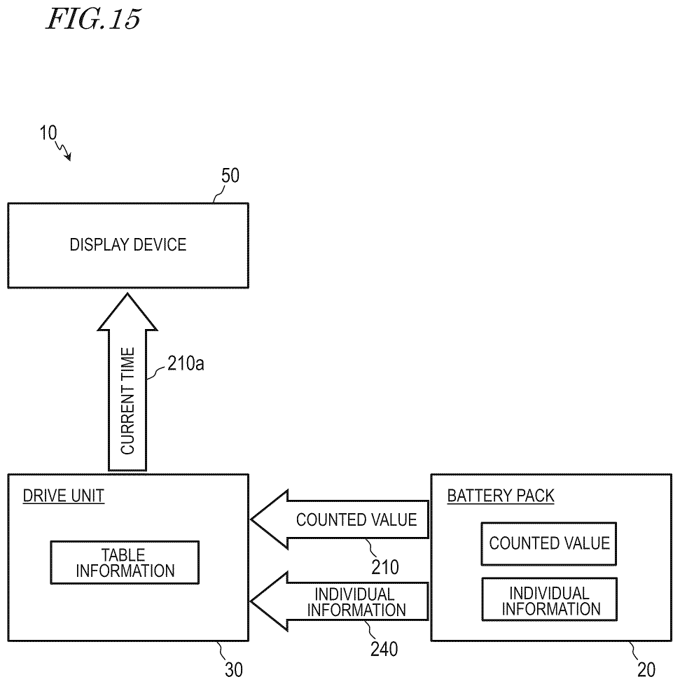

FIG. 15 shows still another example of operation of the battery pack 20, the drive unit 30 and the display 50.

In the example shown in FIG. 15, the processor 121 of the battery pack 20 outputs time information 210 representing a counted value and the individual information 240 to the drive unit 30. The ROM 132 of the drive unit 30 stores the table information 230.

The processor 131 of the drive unit 30 acquires the individual information 240 output by the battery pack 20. The processor 131 acquires an offset value corresponding to the individual information 240 based on the table information 230. The processor 131 calculates current time based on the counted value represented by the time information 210 and the offset value acquired from the table information 230.

The processor 131 outputs time information 210a representing the calculated current time to the display 50. The processor 151 of the display 50 receives the time information 210a and causes the display panel 155 to display the current time represented by the time information 210a, and thus may display the current time.

The processor 131 of the drive unit 30 calculates the current time so that the processor 151 of the display 50 does not need to calculate the current time.

Now, a charger to charge the battery pack 20 will be described.

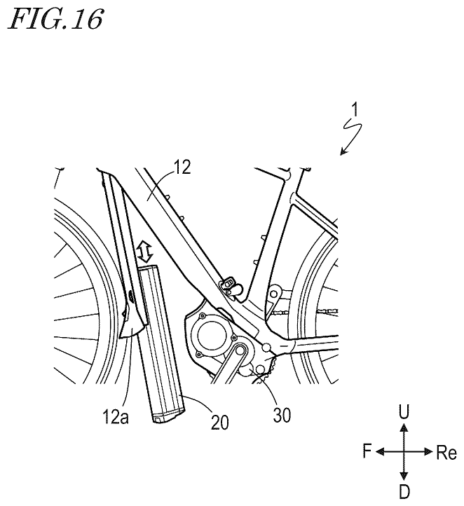

As described above, the battery pack 20 may be attachable to, or detachable from, the electrically assisted bicycle 1. FIG. 16 shows how to attach the battery pack 20 to, or detach the battery pack 20 from, the electrically assisted bicycle 1. In this example, the battery pack 20 is provided inside the down tube 12. At least a portion of the down tube 12 has a U-shaped cross-section, and the down tube 12 is provided with a cover 12a to cover the U-shaped portion. The cover 12a may be opened to detach the battery pack 20 from the down tube 12 or to attach the battery pack 20 to the down tube 12.

In a state of being detached from the electrically assisted bicycle 1, the battery pack 20 may be connected with an external charger to be charged.

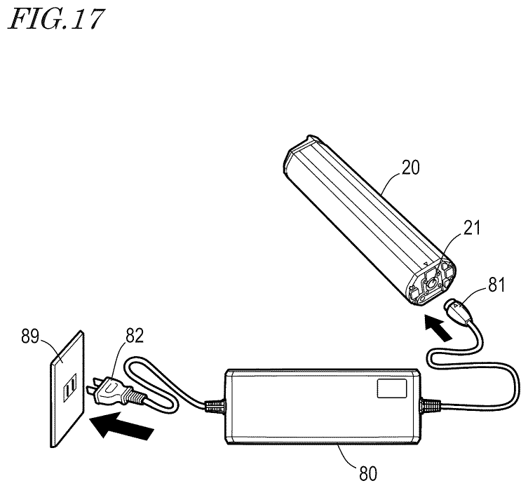

FIG. 17 shows a charger 80. A plug 82 of the charger 80 is connected with a commercial power source (e.g., an outlet) 89, and a plug 81 of the charger 80 is connected with a receptacle 21 of the battery pack 20 so that the battery pack 20 may be charged.

The battery pack 20 is preferably an attachable/detachable portable battery. Therefore, even in the case where, for example, no charger to charge the battery pack 20 is provided at a parking site, the battery pack 20 may be carried to a place where there is a charger and be charged.

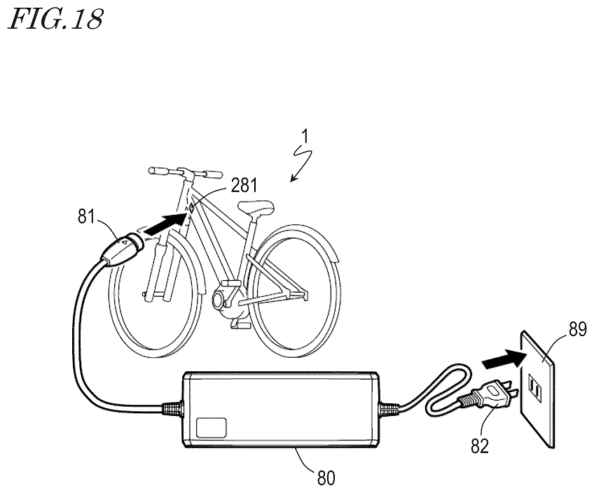

The battery pack 20 may be charged in a state of being attached to the electrically assisted bicycle 1. FIG. 18 shows how to charge the battery pack 20 attached to the electrically assisted bicycle 1. In the example shown in FIG. 18, the plug 82 of the charger 80 is connected with a commercial power source 89, and the plug 81 of the charger 80 is connected with the receptacle 281 provided in the electrically assisted bicycle 1 so that the battery pack 20 may be charged.

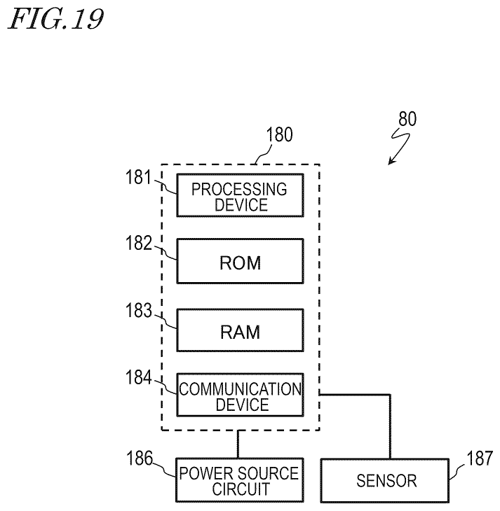

FIG. 19 is a block diagram showing an example of a hardware configuration of the charger 80. The charger 80 includes a controller 180, a power source circuit 186, and a sensor 187.

The controller 180 includes a processor 181, a ROM 182, a RAM 183, and a communication device 184. The configurations of the processor 181, the ROM 182 and the RAM 183 are substantially the same as those of the processor 151, the ROM 152 and the RAM 153 of the display 50 and will not be described.

The ROM 182 stores a computer program (or firmware) to cause the processor 181 to execute processes. The computer program may be stored on the ROM 182 at the time of production of the charger 80. The computer program may be provided to the charger 80 via a storage medium or an electric communication line. Such a computer program may be marketed as commercial software. The processor 181 consecutively executes a computer program describing a group of commands to execute various processes (computer program stored on the ROM 182) to perform a desired process. The processor 181 controls a charging operation of the charger 80. The processor 181 monitors the output current, the output voltage, the temperature or the like of the charger 80.

The power source circuit 186 includes, for example, an AC/DC converter to convert an AC voltage supplied from the commercial power source 89 into a DC voltage. The sensor 187 is a current sensor to detect the current of the power source circuit 186, a voltage sensor to detect the voltage of the power source circuit 186, a temperature sensor to detect the temperature of the power source circuit 186, or the like. The processor 181 monitors the current, the voltage, the temperature or the like of the power source circuit 186 based on an output signal from the sensor 187.

To be charged, the battery pack 20 is electrically connected with the charger 80. The processor 181 controls operations of the power source circuit 186. The power source circuit 186 generates a DC current to charge the battery pack 20 and outputs the DC current to the battery pack 20, and thus the battery pack 20 is charged.

The communication device 184 is a communication module for wired communication with the battery pack 20. The communication may be performed by a communication system such as, for example, a CAN. The communication device 184 may perform wireless communication with the battery pack 20.

The communication device 184 may communicate with an external device other than the battery pack 20. For example, the communication device 184 may communicate with a home network system or the like. In this case, the communication device 184 may perform wired communication and/or wireless communication. The communication device 184 may perform wired communication in compliance with a communication protocol such as, for example, USB, IEEE1394 (registered trademark), Ethernet (registered trademark) or the like. The communication device 184 may perform wireless communication in compliance with, for example, a Bluetooth (registered trademark) and/or Wi-Fi (registered trademark) protocol. The communication device 184 may be a communication module capable of performing wireless communication in compliance with a communication system of BLE or LPWA. The communication device 184 may perform wireless communication using a mobile telephone line or a line transmitting information via an artificial satellite.

Now, setting a current time in the battery pack 20 using the charger 80 will be described.

The setting of the current time in the battery pack 20 may be performed using the charger 80. In this case, the processor 181 of the charger 80 may calculate the current time.

The charger 80 may, for example, acquire current time information representing current time from an external device to set the current time therein. The external device may be, for example, the mobile terminal device 90, a personal computer, or another electric device. For example, the mobile terminal device 90 outputs the current time information to the charger 80. The processor 181 of the charger 80 may set the current time based on the received current time information. In the case where current time is already set in the charger 80, the processor 181 may reset the current time based on the received current time information.

The charger 80 may communicate with a home network system or the like. In this case, the charger 80 may acquire current time information from another electric device connected with the home network system. The charger 80 may receive a signal from a GNSS (Global Navigation Satellite System) satellite to set the current time. The charger 80 may include a plurality of switches and the user may operate these switches to set the current time.

The processor 181 of the charger 80 outputs current time information representing the calculated current time to the battery pack 20. The processor 121 of the battery pack 20 sets the current time based on the received current time information. As a result, the processor 121 may set the current time in the battery pack 20 based on the current time stored in the charger 80.

The processor 121 calculates an offset value based on the current counted value and the current time and stores the calculated offset value on the ROM 122. The processor 121 may calculate the current time based on the calculated offset value and the counted value. In the case where no current time is set in the battery pack 20, the processor 121 may start calculating the current time based on the calculated offset value.

In the case where current time is already set in the battery pack 20, the processor 121 may reset the current time based on the current time information received from the charger 80. The current time calculated by the processor 121 may occasionally be shifted little by little with the passage of time. The current time stored in the battery pack 20 is reset to the current time stored in the charger 80 so that the shifted current time stored in the battery pack 20 may be corrected.

The offset value may be calculated by the processor 181 of the charger 80. In this case, the processor 121 of the battery pack 20 outputs time information 210 representing a counted value to the charger 80.

The processor 181 calculates an offset value based on the current time and the counted value. The processor 181 outputs information representing the calculated offset value to the battery pack 20. The processor 121 of the battery pack 20 may set an offset value based on the acquired information representing the offset value. In the case where an offset value is already set in the battery pack 20, the processor 121 may reset the offset value based on the information received from the charger 80.

The external device such as the mobile terminal device 90 or the like and the battery pack 20 may directly communicate with each other to set the current time in the battery pack 20. The external device may be, for example, the mobile terminal device 90, a personal computer or another electric device.

In this case, the communication device 124 of the battery pack 20 may perform wired communication and/or wireless communication. The communication device 124 may perform wired communication in compliance with a communication protocol such as, for example, USB, IEEE1394 (registered trademark), Ethernet (registered trademark) or the like. The communication device 124 may perform wireless communication in compliance with, for example, a Bluetooth (registered trademark) and/or Wi-Fi (registered trademark) protocol. The communication device 124 may be a communication module capable of performing wireless communication in compliance with a communication system of BLE or LPWA. The communication device 124 may perform wireless communication using a mobile telephone line or a line transmitting information via an artificial satellite.

For example, the mobile terminal device 90 outputs current time information to the battery pack 20. The processor 121 of the battery pack 20 may set current time based on the received current time information. In the case where current time is already set in the battery pack 20, the processor 121 may reset the current time based on the received current time information.

The battery pack 20 may communicate with a home network system or the like. In this case, the battery pack 20 may acquire current time information from another electric device connected with the home network system. The battery pack 20 may receive a signal from a GNSS (Global Navigation Satellite System) satellite to set the current time. The battery pack 20 may include a plurality of switches and the user may operate these switches to set the current time.

The processor 121 calculates an offset value based on the current counted value and the acquired current time information and stores the calculated offset value on the ROM 122. The processor 121 may calculate current time based on the calculated offset value and the counted value. In the case where no current time is set in the battery pack 20, the processor 121 may start calculating the current time based on the calculated offset value.

In the case where current time is already set in the battery pack 20, the processor 121 may reset the current time based on the acquired current time information. The current time calculated by the processor 121 may occasionally be shifted little by little with the passage of time. The current time stored in the battery pack 20 is reset to the current time acquired from the external device so that the shifted current time stored in the battery pack 20 may be corrected.

The offset value may be calculated by an external device such as the mobile terminal device 90 or the like. In this case, the processor 121 of the battery pack 20 outputs time information 210 representing a counted value to, for example, the mobile terminal device 90. A processor of the mobile terminal device 90 calculates an offset value based on the current time and the counted value. The processor of the mobile terminal device 90 outputs information representing the calculated offset value to the battery pack 20. The processor 121 of the battery pack 20 may set an offset value based on the acquired information representing the offset value. In the case where an offset value is already set in the battery pack 20, the processor 121 may reset the offset value based on the information received from the mobile terminal device 90.

Now, an example embodiment of the electrically assisted bicycle 1 including a plurality of the battery packs 20 mounted thereon will be described. The electrically assisted bicycle 1 may occasionally include a plurality of the battery packs 20 mounted thereon in order to extend the distance by which the electrically assisted bicycle 1 can run with the electric motor 32 generating assist power. Display of the current time in such a case will be described.

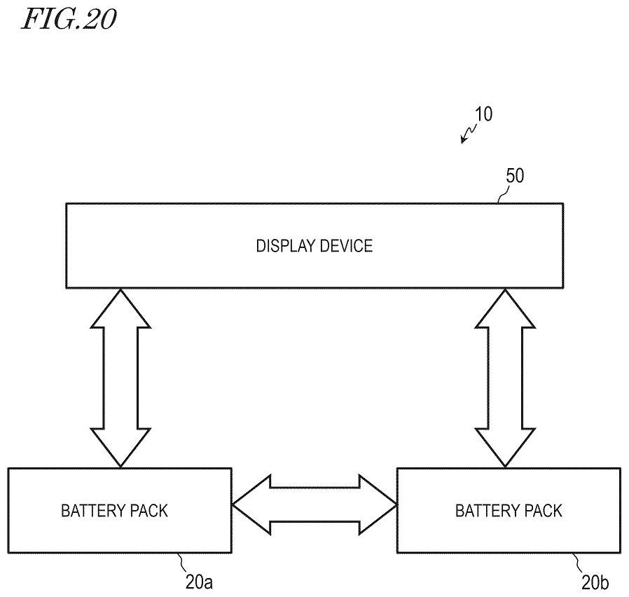

FIG. 20 shows a plurality of battery packs to be mounted on the electrically assisted bicycle 1. In the example shown in FIG. 20, two battery packs 20a and 20b as the plurality of battery packs 20 are mounted on the electrically assisted bicycle 1. The two battery packs 20a and 20b may be mounted at any position. For example, the battery packs 20a and 20b may be mounted on at least one among the down tube 12, the top tube 14 and the seat tube 16 of the electrically assisted bicycle 1. Three or more battery packs 20 may be mounted on the electrically assisted bicycle 1. In this example, the battery pack 20a includes a processor 121a as the processor 121, and the battery pack 20b includes a processor 121b as the processor 121.

In this example, the processor 151 of the display 50 acquires time information 210 from one of the battery packs 20a and 20b.

For example, the processor 151 acquires the time information 210 from the battery pack 20 located at a predetermined position in the electrically assisted bicycle 1. In the case where, for example, the battery pack 20a is located in the down tube 12 and the battery pack 20b is located in the seat tube 16, the processor 151 acquires the time information 210 from the battery pack 20a provided in the down tube 12.

The time information 210 is acquired from either one of the battery packs 20, instead of from the plurality of battery packs 20, so that even in the case where there is a difference in the current time among the plurality of battery packs 20, the display 50 is able to display the current time with no processing error.

The method for selecting the battery pack 20 from which the time information is to be acquired is not limited to the above-described method and may be any appropriate method. For example, the time information 210 may be acquired from, among the plurality of battery packs 20, the battery pack 20 in the middle of supplying electric power to the drive unit 30 and the display 50.

In the case where, for example, the battery packs 20 each store log information representing the date/time when the current time was set, the time information 210 may be acquired from, among the plurality of battery packs 20, the battery pack 20 in which the current time was set on the date/time from when the shortest time has elapsed. Alternatively, for example, the time information 210 may be acquired from, among the plurality of battery packs 20, the battery pack 20 having the most advanced current time.

In the case where the current time is set in one of two battery packs 20 but the current time is not set in the other battery pack 20, the time information 210 is acquired from the battery pack 20 in which the current time is set.

In the case where the current time is set in one of two battery packs 20 but the current time is not set in the other battery pack 20, the current time in the battery pack 20 having no current time set may be set based on current time information that is output by the battery pack 20 having the current time set.

It is assumed that, for example, the current time is set in the battery pack 20a but the current time is not set in the battery pack 20b. In this case, for example, the processor 121a of the battery pack 20a outputs current time information to the battery pack 20b. The processor 121b of the battery pack 20b sets current time based on the acquired current time information. As a result, the current time may be set in the battery pack 20b which did not have the current time set.

Alternatively, for example, the processor 121a of the battery pack 20a may output current time information to the display 50. The processor 151 of the display 50 outputs the acquired current time information to the battery pack 20b. The processor 121b of the battery pack 20b may set current time based on the acquired current time information.

In the above-described example embodiments, the electrically assisted bicycle 1 is described as an example of the electrically assisted vehicle. The present invention is not limited to this. For example, the electrically assisted vehicle may be an electrically assisted tricycle.

In the above-described example embodiments, the driving wheel to which the power of a human body generated by the rider stepping on the pedals and the assist power generated by the electric motor are conveyed is the rear wheel. The present invention is not limited to this. The power of the human body and the assist power may be conveyed to the front wheel, or may be conveyed to both of the front wheel and the rear wheel, in accordance with the type of the electrically assisted vehicle. The present invention may be applied to an electrically assisted bicycle including a hub motor provided on the front wheel.

Illustrative example embodiments of the present invention have been described above. This specification discloses time display systems, driving systems, electrically assisted vehicles, battery packs, time display methods, and computer programs as described below.

A time display system 10 for an electrically assisted vehicle 1 includes a display 50 and at least one processor 151, 131 configured or programmed to acquire time information 210 representing information on time that is output by a battery pack 20 that supplies electric power to an electric motor 32 that generates drive power to cause the electrically assisted vehicle 1 to travel, and cause the display 50 to display current time based on the time information 210.

In a case of including a function to display the current time, the display 50 of a conventional electrically assisted vehicle 1 includes a built-in battery cell such as a coin cell battery. The display 50 includes such a built-in battery cell so that even in a state where the battery pack 20 supplies power to the electric motor 32 is detached from the electrically assisted vehicle 1, the processor 151 of the display 50 may calculate the current time.

However, a space inside the housing of the display 50 needs to accommodate various components. There is a problem that in order to provide a space where the battery cell is located, the other components are restricted in terms of the positional arrangement thereof. In addition, the user may find it troublesome to replace the battery cell when the remaining capacity of the battery cell become zero.

According to an example embodiment of the present invention, the at least one processor 151, 131 is configured or programmed to cause the display 50 to display the current time based on the time information 210 output by the battery pack 20. As a result, the display 50 may display the current time even if the display 50 does not include a built-in battery cell. This may improve the degree of freedom of the positional arrangement of the components of the display 50 and may also make it unnecessary to replace the battery cell.

The battery pack 20 includes a plurality of battery cells, and may keep on counting the time using the electric current output by the plurality of battery cells.

In the time display system 10, the time information 210 output by the battery pack 20 represents current time.

With such a configuration, even if a processor other than the processor 121 of the battery pack 20 does not calculate the current time, the display 50 is able to display the current time.

In the time display system 10, the at least one processor 151, 131 is configured or programmed to acquire current time information representing the current time based on a current time setting operation performed by a user on the display 50, and output the acquired current time information to the battery pack 20, and a processor 121 of the battery pack 20 is configured or programmed to set the current time based on the current time information output by the at least one processor 151, 131.

With such a configuration, the current time may be set in the battery pack 20 based on the current time set by the user.

In the time display system 10, the at least one processor 151, 131 is configured or programmed to acquire current time information representing the current time based on a current time setting operation performed by a user on the display 50, and output the current time information to the battery pack 20, and a processor 121 of the battery pack 20 is configured or programmed to reset the current time to be calculated based on the current time information output by the at least one processor 151, 131.

The current time calculated by the processor 121 of the battery pack 20 may occasionally be shifted little by little with the passage of time. The current time stored in the battery pack 20 is reset to the current time set by the user so that the shifted current time stored in the battery pack 20 may be corrected.

In the time display system 10, the time information 210 output by the battery pack 20 represents a first value on time that is not current time, and the at least one processor 151, 131 is configured or programmed to calculate the current time based on the first value and a second value to convert the first value into the current time.

With such a configuration, the current time may be calculated based on the time information 210 representing the first value (e.g., the counted value) output by the battery pack 20.

In the time display system 10, the time information 210 output by the battery pack 20 represents the second value.

With such a configuration, the current time may be calculated based on the information on the first value and on the second value output by the battery pack 20.

The time display system 10 may further include a storage 152, 132 to store information representing the second value, wherein the at least one processor 151, 131 is configured or programmed to read the information from the storage 152, 132, and calculate the current time based on the information representing the second value.

With such a configuration, the current time may be calculated based on the time information 210 representing the first value output by the battery pack 20.

The time display system 10 may further include a storage 152, 132 to store table information 230 representing a relationship between individual information 240 of the battery pack 20 and the second value, wherein the at least one processor 151, 131 is configured or programmed to acquire the individual information 240 output by the battery pack 20, and acquire the second value to be used to calculate the current time based on the acquired individual information 240 and the table information 230.

With such a configuration, the second value may be acquired based on the individual information 240 output by the battery pack 20.

In the time display system 10, the first value is a counted value acquired by a processor 121 of the battery pack 20 counting time.

With such a configuration, the current time may be calculated based on the time information 210 representing the counted value output by the battery pack 20.

In the time display system 10, the second value is an offset value.

With such a configuration, the current time may be calculated based on the offset value.

In the time display system 10, a processor 121 of the battery pack 20 is configured or programmed to output information representing the first value to the at least one processor 151, 131 configured or programmed to acquire current time information representing the current time based on a current time setting operation performed by a user on the display 50, calculate the second value based on the current time information and the first value acquired from the battery pack 20, and output information representing the calculated second value to the battery pack 20, and the processor 121 of the battery pack 20 is configured or programmed to acquire the information from the at least one processor 151, 131, and set the second value to be used to calculate current time based on the information representing the second value.

With such a configuration, the second value (e.g., offset value) may be set in the battery pack 20 based on the current time set by the user.

The time display system 10 may further include a processor 121 of the battery pack 20 configured or programmed to output information representing the first value to the at least one processor 151, 131 configured or programmed to acquire current time information representing the current time based on a current time setting operation performed by a user on the display 50, calculate the second value based on the acquired current time information and the first value acquired from the battery pack 20, and output information representing the calculated second value to the battery pack 20, and the processor 121 of the battery pack 20 is configured to programmed to acquire the second value acquired from the at least one processor 151, 131, and reset the second value to be used to calculate current time.

The current time calculated by the processor 121 of the battery pack 20 may occasionally be shifted little by little with the passage of time. The second value (e.g., offset value) stored in the battery pack 20 is reset to the second value calculated by the at least one processor 151, 131 so that the shifted current time may be corrected.

In the time display system 10, in a case where the time information 210 cannot be acquired from the battery pack 20, the at least one processor 151, 131 is configured or programmed to not cause the display 50 to display any current time.

With such a configuration, in the case where the time information 210 cannot be acquired, the display 50 may be caused not to display any current time.

In the time display system 10, the battery pack 20 is able to be charged by a charger 80, a processor 181 of the charger 80 is configured or programmed to output current time information representing the current time to the battery pack 20, and the processor 121 of the battery pack 20 is configured or programmed to set the current time based on the current time information output by the charger 80.

With such a configuration, the current time may be set in the battery pack 20 based on the current time stored in the charger 80.

In the time display system 10, the battery pack 20 is able to be charged by a charger 80, a processor 181 of the charger 80 is configured or programmed to output current time information representing the current time to the battery pack 20, and the processor 121 of the battery pack 20 is configured or programmed to reset the current time to be calculated based on the current time information output by the charger 80.

The current time calculated by the processor 121 of the battery pack 20 may occasionally be shifted little by little with the passage of time. The current time stored in the battery pack 20 is reset to the current time stored in the charger 80 so that the shifted current time may be corrected.

In the time display system 10, the battery pack 20 is able to be charged by a charger 80, a processor 121 of the battery pack 20 is configured or programmed to output information representing the first value to the charger 80, a processor 181 of the charger 80 is configured or programmed to calculate the second value based on the current time and the first value acquired from the battery pack 20, and output information representing the calculated second value to the battery pack 20, and the processor 121 of the battery pack 20 is configured or programmed to reset the second value to be used to calculate current time to the second value acquired from the charger 80.

The current time calculated by the processor 121 of the battery pack 20 may occasionally be shifted little by little with the passage of time. The second value (e.g., offset value) stored in the battery pack 20 is reset to the second value calculated by the charger 80 so that the shifted current time may be corrected.

In the time display system 10, the at least one processor 151, 131 is configured or programmed to acquire current time information representing the current time from an external device 90, and output the current time information to the battery pack 20, and a processor 121 of the battery pack 20 is configured or programmed to reset the current time to be calculated based on the current time information output by the at least one processor 151, 131.

The current time calculated by the processor 121 of the battery pack 20 may occasionally be shifted little by little with the passage of time. The current time stored in the battery pack 20 is reset to the current time acquired from the external device 90 so that the shifted current time may be corrected.

The time display system 10 may further include a processor 121 of the battery pack 20 configured or programmed to output information representing the first value to the at least one processor 151, 131 configured or programmed to acquire current time information representing the current time from an external device 90, calculate the second value based on the current time information acquired from the external device 90 and the first value acquired from the battery pack 20, and output the second value to the battery pack 20, and the processor 121 of the battery pack 20 is configured or programmed to acquire the second value from the at least one processor 151, 131, and reset the second value to be used to calculate current time.

The current time calculated by the processor 121 of the battery pack 20 may occasionally be shifted little by little with the passage of time. The second value (e.g., offset value) stored in the battery pack 20 is reset to the second value calculated by the at least one processor 151, 131 so that the shifted current time may be corrected.

The time display system 10 may further include a processor 121 of the battery pack 20 configured or programmed to acquire current time information representing the current time from an external device 90, and reset the current time to be calculated based on the current time information acquired from the external device 90.

The current time calculated by the processor 121 of the battery pack 20 may occasionally be shifted little by little with the passage of time. The current time stored in the battery pack 20 is reset to the current time stored in the external device 90 so that the shifted current time may be corrected.

The time display system 10 may further include a processor 121 of the battery pack 20 configured or programmed to output the first value to an external device 90, a processor of the external device 90 configured or programmed to calculate the second value based on the current time and the first value output by the battery pack 20, and output the calculated second value to the battery pack 20, and the processor 121 of the battery pack 20 is configured or programmed to reset the second value to be used to calculate current time to the second value output by the external device 90.

The current time calculated by the processor 121 of the battery pack 20 may occasionally be shifted little by little with the passage of time. The offset value stored in the battery pack 20 is reset to the offset value calculated by the external device 90 so that the shifted current time may be corrected.

In the time display system 10, a plurality of the battery packs 20 are mounted on the electrically assisted vehicle 1, and the at least one processor 151, 131 is configured or programmed to acquire the time information 210 from one of the plurality of battery packs 20.

The time information 210 in one battery pack 20 is used so that even in a case where there is a difference in the current time among the plurality of battery packs 20, the display 50 is able to display the current time with no processing error.

In the time display system 10, a plurality of the battery packs 20 are mounted on the electrically assisted vehicle 1, and in a case where the plurality of battery packs 20 include a battery pack 20 in which current time is set and a battery pack 20 in which no current time is set, a processor 121 of the battery pack 20 in which no current time is set is configured or programmed to acquire current time information representing the current time from a processor 121 of the battery pack 20 in which the current time is set, and set the current time based on the acquired current time information.

With such a configuration, the current time may be set in the battery pack 20 in which no current time has been set yet.

In the time display system 10, a plurality of the battery packs 20 are mounted on the electrically assisted vehicle 1, and in a case where the plurality of battery packs 20 include a battery pack 20 in which current time is set and a battery pack 20 in which no current time is set, the at least one processor 151, 131 is configured or programmed to acquire current time information representing the current time from a processor 121 of the battery pack 20 in which the current time is set, and output the current time information to a processor 121 of the battery pack 20 in which no current time is set, and the processor 121 of the battery pack 20 in which no current time is set is configured or programmed to set the current time based on the acquired current time information.

With such a configuration, the current time may be set in the battery pack 20 in which no current time has been set.

In the time display system 10, the at least one processor 151, 131 includes a processor 151 in the display 50.

With such a configuration, the processor 151 of the display 50 may cause the display 50 to display the current time based on the time information 210 output by the battery pack 20.

A driving system 100 may include the time display system 10 of any one of the above.

With such a configuration, the driving system 100 is provided in which the display 50 is able to display the current time and does not need to include a built-in battery cell.

An electrically assisted vehicle 1 may include the time display system 10 of any one of the above.

With such a configuration, the electrically assisted vehicle 1 is provided in which the display 50 is able to display the current time and does not need to include a built-in battery cell.

A time display method for causing a display 50 of an electrically assisted vehicle 1 to display current time, the time display method being executed by at least one computer, the time display method including acquiring time information 210 representing information on time that is output by a battery pack 20 that supplies electric power to an electric motor 32 that generates drive power to cause the electrically assisted vehicle 1 to travel, and causing the display 50 to display current time based on the time information 210.

In a case of including a function to display the current time, the display 50 of the electrically assisted vehicle 1 conventionally includes a built-in battery cell such as a coin cell battery. The display 50 includes such a built-in battery cell so that even in a state where the battery pack 20 that supplies electric power to the electric motor 32 is detached from the electrically assisted vehicle 1, the processor 151 of the display 50 may calculate the current time.

However, a space inside the housing of the display 50 needs to accommodate various components. There is a problem that in order to provide a space where the battery cell is located with certainty, the other components are restricted in terms of the positional arrangement thereof. In addition, the user may find it troublesome to replace the battery cell when the remaining capacity of the battery cell become zero.

According to an example embodiment of the present invention, the at least one processor 151, 131 is configured or programmed to cause the display 50 to display the current time based on the time information 210 output by the battery pack 20. As a result, the display 50 may display the current time even if the display 50 does not include a built-in battery cell. This may improve the degree of freedom of the positional arrangement of the components of the display 50 and may also make it unnecessary to replace the battery cell.

The battery pack 20 includes a plurality of battery cells, and may keep on counting the time using the electric current output by the plurality of battery cells.

A non-transitory computer readable medium includes a computer program to cause at least one computer to execute a process of causing a display 50 of an electrically assisted vehicle 1 to display current time, the computer program causing the at least one computer to acquire time information 210 representing information on time that is output by a battery pack 20 that supplies electric power to an electric motor 32 that generates drive power to cause the electrically assisted vehicle 1 to travel, and cause the display 50 to display current time based on the time information 210.

In a case of including a function to display the current time, the display 50 of the electrically assisted vehicle 1 conventionally includes a built-in battery cell such as a coin cell battery. The display 50 includes such a built-in battery cell so that even in a state where the battery pack 20 supplying electric power to the electric motor 32 is detached from the electrically assisted vehicle 1, the processor 151 of the display 50 may calculate the current time.

However, a space inside the housing of the display 50 needs to accommodate various components. There is a problem that in order to provide a space where the battery cell is located, the other components are restricted in terms of the positional arrangement thereof. In addition, the user may find it troublesome to replace the battery cell when the remaining capacity of the battery cell become zero.

According to an example embodiment of the present invention, the at least one processor 151, 131 is configured or programmed to cause the display 50 to display the current time based on the time information 210 output by the battery pack 20. As a result, the display 50 may display the current time even if the display 50 does not include a built-in battery cell. This may improve the degree of freedom of the positional arrangement of the components of the display 50 and may also make it unnecessary to replace the battery cell.

The battery pack 20 includes a plurality of battery cells, and may keep on counting the time using the electric current output by the plurality of battery cells.

A battery pack 20 usable to supply electric power to an electric motor 32 of an electrically assisted vehicle 1 includes a plurality of battery cells 126a and a processor 121 configured or programmed to calculate current time, wherein the processor 121 is configured or programmed to output time information 210 representing the calculated current time to a processor 151 configured or programmed to control a display 50 of the electrically assisted vehicle 1.

With such a configuration, the display 50 of the electrically assisted vehicle 1 is able to display the current time without including a built-in battery cell.

Example embodiments of the present invention are particularly useful in the field of electrically assisted vehicles.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A time display system for an electrically assisted vehicle, the time display system comprising:
a display; and
at least one processor configured or programmed to:
acquire time information representing information on a time that is output by a battery pack that supplies electric power to an electric motor that generates drive power to cause the electrically assisted vehicle to travel; and
cause the display to display a current time based on the time information.

2. The time display system of claim 1, wherein the time information output by the battery pack represents current time.

3. The time display system of claim 2, wherein
the at least one processor is configured or programmed to:
acquire current time information representing the current time based on a current time setting operation performed by a user on the display; and
output the current time information to the battery pack; and
a processor of the battery pack is configured or programmed to set the current time based on the current time information output by the at least one processor.

4. The time display system of claim 2, wherein
the at least one processor is configured or programmed to:
acquire current time information representing the current time based on a current time setting operation performed by a user on the display; and
output the current time information to the battery pack; and
a processor of the battery pack is configured or programmed to reset the current time to be calculated based on the current time information output by the at least one processor.

5. The time display system of claim 1, wherein
the time information output by the battery pack represents a first value of time that is not current time; and
the at least one processor is configured or programmed to calculate the current time based on the first value and a second value that converts the first value into the current time.

6. The time display system of claim 5, wherein the time information output by the battery pack represents the second value.

7. The time display system of claim 5, further comprising:
a storage to store information representing the second value; wherein
the at least one processor is configured or programmed to read the information from the storage and calculate the current time based on the information representing the second value.

8. The time display system of claim 5, further comprising:
a storage to store table information representing a relationship between individual information of the battery pack and the second value; wherein
the at least one processor is configured or programmed to:
acquire the individual information output by the battery pack; and
acquire the second value to be used to calculate the current time based on the individual information and the table information.

9. The time display system of claim 5, wherein the first value is a counted value acquired by a processor of the battery pack and representing time counted by the processor.

10. The time display system of claim 5, wherein the second value is an offset value.

11. The time display system of claim 6, further comprising:
a processor of the battery pack configured or programmed to output information representing the first value to the at least one processor; wherein
the at least one processor is configured or programmed to:
acquire current time information representing the current time based on a current time setting operation performed by a user on the display;
calculate the second value based on the acquired current time information and the first value acquired from the battery pack; and
output information representing the calculated second value to the battery pack; and
the processor of the battery pack is configured or programmed to acquire the information from the at least one processor and set the second value to be used to calculate current time based on the information representing the second value.

12. The time display system of claim 6, further comprising:
a processor of the battery pack configured or programmed to output information representing the first value to the at least one processor; wherein
the at least one processor is configured or programmed to:
acquire current time information representing the current time based on a current time setting operation performed by a user on the display;
calculate the second value based on the current time information and the first value acquired from the battery pack; and
output information representing the calculated second value to the battery pack; and
the processor of the battery pack is configured or programmed to reset the second value to be used to calculate current time to the second value acquired from the at least one processor.

13. The time display system of claim 1, wherein in a case where the time information cannot be acquired from the battery pack, the at least one processor is configured or programmed to not cause the display to display any current time.

14. The time display system of claim 2, wherein
the battery pack is able to be charged by a charger;
a processor of the charger is configured or programmed to output current time information representing the current time to the battery pack; and
the processor of the battery pack is configured or programmed to set the current time based on the current time information output by the charger.

15. The time display system of claim 2, wherein
the battery pack is able to charged by a charger;
a processor of the charger is configured or programmed to output current time information representing the current time to the battery pack; and
the processor of the battery pack is configured or programmed to reset the current time to be calculated based on the current time information output by the charger.

16. The time display system of claim 6, wherein
the battery pack is able to be charged by a charger;
a processor of the battery pack is configured or programmed to output information representing the first value to the charger;
a processor of the charger is configured or programmed to:
calculate the second value based on the current time and the first value acquired from the battery pack; and
output information representing the calculated second value to the battery pack; and
the processor of the battery pack is configured or programmed to reset the second value to be used to calculate current time to the second value acquired from the charger.

17. The time display system of claim 2, wherein
the at least one processor is configured or programmed to:
acquire current time information representing the current time from an external device; and
output the current time information to the battery pack; and
a processor of the battery pack is configured or programmed to reset the current time to be calculated based on the current time information output by the at least one processor.

18. The time display system of claim 6, further comprising:
a processor of the battery pack is configured or programmed to output information representing the first value to the at least one processor; wherein
the at least one processor is configured or programmed to:
acquire current time information representing the current time from an external device;
calculate the second value based on the current time information acquired from the external device and the first value acquired from the battery pack; and
output the calculated second value to the battery pack; and
the processor of the battery pack is configured or programmed to reset the second value to be used to calculate current time to the second value acquired from the at least one processor.

19. The time display system of claim 2, further comprising:
a processor of the battery pack configured or programmed to:
acquire current time information representing the current time from an external device; and
reset the current time to be calculated based on the current time information acquired from the external device.

20. The time display system of claim 6, further comprising:
a processor of the battery pack configured or programmed to output the first value to an external device;
a processor of the external device configured or programmed to:
calculate the second value based on the current time and the first value output by the battery pack; and
output the second value to the battery pack; and
the processor of the battery pack is configured or programmed to reset the second value to be used to calculate current time to the second value output by the external device.

21. The time display system of claim 1, wherein
a plurality of battery packs are mounted on the electrically assisted vehicle; and
the at least one processor is configured or programmed to acquire the time information from one of the plurality of battery packs.

22. The time display system of claim 1, wherein
a plurality of battery packs are mounted on the electrically assisted vehicle; and
in a case where the plurality of battery packs include a battery pack in which current time is set and a battery pack in which no current time is set, a processor of the battery pack in which no current time is set is configured or programmed to:
acquire current time information representing the current time from a processor of the battery pack in which the current time is set; and
set the current time based on the current time information.

23. The time display system of claim 1, wherein
a plurality of battery packs are mounted on the electrically assisted vehicle; and
in a case where the plurality of battery packs include a battery pack in which current time is set and a battery pack in which no current time is set, the at least one processor is configured or programmed to:
acquire current time information representing the current time from a processor of the battery pack in which the current time is set; and
output the current time information to a processor of the battery pack in which no current time is set; and
the processor of the battery pack in which no current time is set is configured or programmed to set the current time based on the current time information.

24. A time display method for causing a display of an electrically assisted vehicle to display current time, the time display method being executable by at least one computer and comprising:
acquiring time information representing information on time that is output by a battery pack that supplies electric power to an electric motor that generates drive power to cause the electrically assisted vehicle to travel; and
causing the display to display current time based on the time information.

25. A battery pack to supply electric power to an electric motor of an electrically assisted vehicle, the battery pack comprising:
a plurality of battery cells; and
a processor configured or programmed to calculate current time; wherein
the processor is configured or programmed to output time information representing the current time to a processor configured or programmed to control a display of the electrically assisted vehicle.
